(19) United States
(12) Patent Application Publication
(10) Pub. No.: US 2026/0095931 A1
(43) Pub. Date: Apr. 2, 2026

(54) SIGNALING FOR TRANSMISSION OF UPLINK CONTROL INFORMATION IN A COMPONENT CARRIER GROUP

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US)

(21) Appl. No.: 18/905,093

(22) Filed: Oct. 2, 2024

(51) Int. Cl. H04W 72/52

(52) U.S. Cl. CPC H04W 72/52

(57) ABSTRACT

Methods, systems, and devices for wireless communications are described. A user equipment (UE) may receive first control messages scheduling a downlink transmission in a first cell group including a first cell, the first control messages indicating that a first uplink control information (UCI) carrying feedback associated with the downlink transmission is to be transmitted to the first cell in the first cell group and that a second UCI carrying the feedback is to be transmitted to a second cell of a second cell group. The UE may transmit, to the first cell of the first cell group, the first UCI carrying the feedback associated with the downlink transmission. The UE may transmit, to the second cell of the second cell group and using a resource of the second cell that is based on the first control messages, the second UCI carrying the feedback associated with the downlink transmission.

### FIELD OF TECHNOLOGY

The following relates to wireless communications, including signaling for transmission of uplink control information (UCI) in a component carrier (CC) group.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). UEs may receive downlink transmissions and transmit feedback corresponding to the downlink transmissions.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more first control messages scheduling a downlink transmission in a first cell group including a first cell, the one or more first control messages indicating that a first uplink control information (UCI) carrying feedback associated with the downlink transmission in the first cell group is to be transmitted to the first cell in the first cell group and that a second UCI carrying the feedback associated with the downlink transmission in the first cell group is to be transmitted to a second cell of a second cell group, transmitting, to the first cell of the first cell group in accordance with receiving the one or more first control messages, the first UCI carrying the feedback associated with the downlink transmission in the first cell group, and transmitting, to the second cell of the second cell group and using a resource of the second cell that is based on the one or more first control messages, the second UCI carrying the feedback associated with the downlink transmission in the first cell group.

A UE for wireless communications is described. The UE may include one or more memories storing processor executable code, and one or more processors coupled with the one or more memories. The one or more processors may individually or collectively be operable to execute the code to cause the UE to receive one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group, transmit, to the first cell of the first cell group in accordance with receiving the one or more first control messages, the first UCI carrying the feedback associated with the downlink transmission in the first cell group, and transmit, to the second cell of the second cell group and using a resource of the second cell that is based on the one or more first control messages, the second UCI carrying the feedback associated with the downlink transmission in the first cell group.

Another UE for wireless communications is described. The UE may include means for receiving one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group, means for transmitting, to the first cell of the first cell group in accordance with receiving the one or more first control messages, the first UCI carrying the feedback associated with the downlink transmission in the first cell group, and means for transmitting, to the second cell of the second cell group and using a resource of the second cell that is based on the one or more first control messages, the second UCI carrying the feedback associated with the downlink transmission in the first cell group.

A non-transitory computer-readable medium storing code for wireless communications is described. The code may include instructions executable by one or more processors to receive one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group, transmit, to the first cell of the first cell group in accordance with receiving the one or more first control messages, the first UCI carrying the feedback associated with the downlink transmission in the first cell group, and transmit, to the second cell of the second cell group and using a resource of the second cell that is based on the one or more first control messages, the second UCI carrying the feedback associated with the downlink transmission in the first cell group.

In some examples of the method, UEs, and non-transitory computer-readable medium described herein, the first slot offset indicator field indicates a first quantity of slots between the downlink transmission and the first UCI, the second slot offset indicator field indicates a second quantity of slots between the downlink transmission and the second UCI or between the first UCI and the second UCI, and the resource of the second cell includes a slot that may be based on the second slot offset indicator field.

Some examples of the method, UEs, and non-transitory computer-readable medium described herein may further include operations, features, means, or instructions for receiving a radio resource control (RRC) message including an indication of a set of multiple slot offsets, where the second quantity of slots may be one of the set of multiple slot offsets.

Some examples of the method, UEs, and non-transitory computer-readable medium described herein may further include operations, features, means, or instructions for constructing a payload of the second UCI based on a semi-static codebook in accordance with a set of candidate physical downlink shared channel (PDSCH) receptions that may be based on the set of multiple slot offsets.

In some examples of the method, UEs, and non-transitory computer-readable medium described herein, the resource includes a first available uplink slot of a reference component carrier of the second cell group.

In some examples of the method, UEs, and non-transitory computer-readable medium described herein, the first available uplink slot occurs after a first slot in which downlink transmission may be received by the UE, after a quantity of slots after the first slot, or after a second slot in which the first UCI may be transmitted by the UE.

Some examples of the method, UEs, and non-transitory computer-readable medium described herein may further include operations, features, means, or instructions for receiving an indication of a semi-static time division duplexing (TDD) configuration of the reference component carrier, where the first available uplink slot includes one or more uplink symbols, one or more flexible symbols, or both based on the semi-static TDD configuration.

Some examples of the method, UEs, and non-transitory computer-readable medium described herein may further include operations, features, means, or instructions for receiving one or more RRC messages including an indication of a periodic pattern, where the periodic pattern includes the first available uplink slot.

In some examples of the method, UEs, and non-transitory computer-readable medium described herein, the reference component carrier includes a physical uplink control channel (PUCCH) cell of the second cell group, a component carrier having a lowest index within the second cell group, or a component carrier with a lowest subcarrier spacing within the second cell group.

In some examples of the method, UEs, and non-transitory computer-readable medium described herein, the resource includes a slot that may be based on a slot offset indicator or a first available uplink slot of a reference component carrier in accordance with an RRC configuration or a format of the one or more first control messages.

In some examples of the method, UEs, and non-transitory computer-readable medium described herein, the one or more first control messages include a first PUCCH resource indicator (PRI) field associated with the first UCI and a second PRI field associated with the second UCI and the resource may be based on the second PRI field.

In some examples of the method, UEs, and non-transitory computer-readable medium described herein, the resource may be based on a payload size of the second UCI.

Some examples of the method, UEs, and non-transitory computer-readable medium described herein may further include operations, features, means, or instructions for receiving one or more RRC messages indicating a first set of multiple PUCCH resources in the second cell allocated for transmission of the second UCI carrying the feedback associated with the downlink transmission in the first cell group, where the resource may be one of the set of multiple PUCCH resources.

In some examples of the method, UEs, and non-transitory computer-readable medium described herein, the resource may be included in a configured grant physical uplink shared channel (PUSCH) of the second cell group.

In some examples of the method, UEs, and non-transitory computer-readable medium described herein, the one or more first control messages further include a configured grant configuration identifier that references the second cell group and the resource may be included in configured grant PUSCH based on the configured grant configuration identifier.

In some examples of the method, UEs, and non-transitory computer-readable medium described herein, the configured grant PUSCH carrying the second UCI may be from a set of multiple configured grant PUSCH occasions and the configured grant PUSCH occurs on or after a slot that may be based on the one or more first control messages.

In some examples of the method, UEs, and non-transitory computer-readable medium described herein, the feedback of the second UCI may be based on a one-shot codebook in accordance with the one or more first control messages including a field indicative of the one-shot codebook.

In some examples of the method, UEs, and non-transitory computer-readable medium described herein, the one or more first control messages indicate one or more hybrid automatic repeat request (HARQ) process identifiers, component carriers, or both for which the one-shot codebook may be configured for the feedback of the second UCI.

In some examples of the method, UEs, and non-transitory computer-readable medium described herein, the feedback of the second UCI may be based on a dynamic codebook in accordance with the one or more first control messages including one or more downlink assignment index (DAI) fields.

In some examples of the method, UEs, and non-transitory computer-readable medium described herein, the one or more DAI fields include a first DAI field associated with the first UCI, a second DAI field associated with the second UCI, or a third DAI field associated with the first UCI and the second UCI.

Some examples of the method, UEs, and non-transitory computer-readable medium described herein may further include operations, features, means, or instructions for receiving a first RRC message indicating a first codebook type for the feedback of the first UCI and receiving a second RRC message separate from the first RRC message indicating a second codebook type for the feedback of the second UCI.

In some examples of the method, UEs, and non-transitory computer-readable medium described herein, transmitting the second UCI may include operations, features, means, or instructions for transmitting the second UCI using a transmit power that may be based on a first transmit power control command of first downlink control information that schedules the downlink transmission in the first cell group.

In some examples of the method, UEs, and non-transitory computer-readable medium described herein, and the method, apparatuses, and non-transitory computer-readable medium may include further operations, features, means, or instructions for transmitting the first UCI using a transmit power that may be based on the first transmit power control command of the first downlink control information that schedules the downlink transmission in the first cell group.

In some examples of the method, UEs, and non-transitory computer-readable medium described herein, transmitting the second UCI may include operations, features, means, or instructions for transmitting the second UCI using a transmit power that may be based on a first transmit power control command of first downlink control information received in the second cell group.

Some examples of the method, UEs, and non-transitory computer-readable medium described herein may further include operations, features, means, or instructions for transmitting the second UCI to the second cell of the second cell group via the resource that may be time-division multiplexed with a second resource of the second cell or via the resource that may be on a first channel of the second cell that includes a second channel carrying information for the second cell group.

Some examples of the method, UEs, and non-transitory computer-readable medium described herein may further include operations, features, means, or instructions for refraining from transmitting information for the second cell group based on the resource overlapping with at least a portion of a second resource scheduling for carrying the information for the second cell group.

Some examples of the method, UEs, and non-transitory computer-readable medium described herein may further include operations, features, means, or instructions for multiplexing the second UCI with information for the second cell group based on the resource that may be to carry the feedback at least partially overlapping with a second resource that may be to carry the information for the second cell group.

Some examples of the method, UEs, and non-transitory computer-readable medium described herein may further include operations, features, means, or instructions for determining whether to multiplex the second UCI with information for the second cell group based on the resource that may be to carry the second UCI at least partially overlapping with a second resource that may be to carry the information for the second cell group, where the UE determines to multiplex the second UCI with the information when the information may be not second feedback associated with a downlink transmission in the second cell group, and where the UE determines to transmit the second UCI separate from the information when the information includes the second feedback associated with the downlink transmission in the second cell group.

A method for wireless communications by a network entity supporting a first cell group and a second cell group is described. The method may include outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group, obtaining, via the first cell of the first cell group in accordance with the one or more first control messages, the first UCI carrying the feedback associated with the downlink transmission in the first cell group, and obtaining, via the second cell of the second cell group and a resource of the second cell that is based on the one or more first control messages, the second UCI carrying the feedback associated with the downlink transmission in the first cell group.

A network entity supporting a first cell group and a second cell group for wireless communications is described. The network entity supporting a first cell group and a second cell group may include one or more memories storing processor executable code, and one or more processors coupled with the one or more memories. The one or more processors may individually or collectively be operable to execute the code to cause the network entity supporting a first cell group and a second cell group to output one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group, obtain, via the first cell of the first cell group in accordance with the one or more first control messages, the first UCI carrying the feedback associated with the downlink transmission in the first cell group, and obtain, via the second cell of the second cell group and a resource of the second cell that is based on the one or more first control messages, the second UCI carrying the feedback associated with the downlink transmission in the first cell group.

Another network entity supporting a first cell group and a second cell group for wireless communications is described. The network entity supporting a first cell group and a second cell group may include means for outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group, means for obtaining, via the first cell of the first cell group in accordance with the one or more first control messages, the first UCI carrying the feedback associated with the downlink transmission in the first cell group, and means for obtaining, via the second cell of the second cell group and a resource of the second cell that is based on the one or more first control messages, the second UCI carrying the feedback associated with the downlink transmission in the first cell group.

A non-transitory computer-readable medium storing code for wireless communications is described. The code may include instructions executable by one or more processors to output one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group, obtain, via the first cell of the first cell group in accordance with the one or more first control messages, the first UCI carrying the feedback associated with the downlink transmission in the first cell group, and obtain, via the second cell of the second cell group and a resource of the second cell that is based on the one or more first control messages, the second UCI carrying the feedback associated with the downlink transmission in the first cell group.

In some examples of the method, network entity supporting a first cell groups and a second cell groups, and non-transitory computer-readable medium described herein, the first slot offset indicator field indicates a first quantity of slots between the downlink transmission and the first UCI, the second slot offset indicator field indicates a second quantity of slots between the downlink transmission and the second UCI or between the first UCI and the second UCI, and the resource of the second cell includes a slot that may be based on the second slot offset indicator field.

Some examples of the method, network entity supporting a first cell groups and a second cell groups, and non-transitory computer-readable medium described herein may further include operations, features, means, or instructions for transmitting an RRC message including an indication of a set of multiple slot offsets, where the second quantity of slots may be one of the set of multiple slot offsets.

In some examples of the method, network entity supporting a first cell groups and a second cell groups, and non-transitory computer-readable medium described herein, the one or more first control messages include a first PRI field associated with the first UCI and a second PRI field associated with the second UCI and the resource may be based on the second PRI field.

Some examples of the method, network entity supporting a first cell groups and a second cell groups, and non-transitory computer-readable medium described herein may further include operations, features, means, or instructions for outputting one or more RRC messages indicating a first set of multiple PUCCH resources allocated for the first UCI and a second set of multiple PUCCH resources allocated for the second UCI, where the second set of multiple PUCCH resources include the resource.

In some examples of the method, network entity supporting a first cell groups and a second cell groups, and non-transitory computer-readable medium described herein, the resource may be included in a configured grant PUSCH of the second cell group.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support signaling for transmission of uplink control information (UCI) in a component carrier (CC) group in accordance with one or more aspects of the present disclosure.

FIG. 3 shows an example of a slot diagram that supports signaling for transmission of UCI in a CC group in accordance with one or more aspects of the present disclosure.

FIG. 4 shows an example of a process flow that supports signaling for transmission of UCI in a CC group in accordance with one or more aspects of the present disclosure.

FIGS. 5 and 6 show block diagrams of devices that support signaling for transmission of UCI in a CC group in accordance with one or more aspects of the present disclosure.

FIG. 7 shows a block diagram of a communications manager that supports signaling for transmission of UCI in a CC group in accordance with one or more aspects of the present disclosure.

FIG. 8 shows a diagram of a system including a device that supports signaling for transmission of UCI in a CC group in accordance with one or more aspects of the present disclosure.

FIGS. 9 and 10 show block diagrams of devices that support signaling for transmission of UCI in a CC group in accordance with one or more aspects of the present disclosure.

FIG. 11 shows a block diagram of a communications manager that supports signaling for transmission of UCI in a CC group in accordance with one or more aspects of the present disclosure.

FIG. 12 shows a diagram of a system including a device that supports signaling for transmission of UCI in a CC group in accordance with one or more aspects of the present disclosure.

FIGS. 13 through 16 show flowcharts illustrating methods that support signaling for transmission of UCI in a CC group in accordance with one or more aspects of the present disclosure.

### DETAILED DESCRIPTION

Wireless networks may support carrier aggregation (CA) or dual-connectivity (DC) communication techniques where a user equipment (UE) is configured with multiple cell groups. For example, the UE may be configured with a primary cell (PCell) of a master cell group (MCG) or a primary secondary cell (PSCell) of a secondary cell group (SCG) (e.g., in DC configurations). Each cell group may have at least one cell designated for receiving physical uplink control channel (PUCCH) transmissions from the UE. The PUCCH transmissions may be used for scheduling communications between the UE and each cell group, for performing link adaptation, providing feedback, or for other techniques. However, in some cases, the cells within one or more of the cell groups may not be collocated, which may introduce latency associated with backhaul communications between the cell groups, such as for PUCCH transmissions that relate to another cell group. Accordingly, PUCCH transmissions between non-collocated cell groups may fail to satisfy associated latency requirements.

Accordingly, aspects of the techniques described herein provide for uplink control information (UCI) (e.g., PUCCH transmissions) associated with a second cell group (e.g., a SCG) being provided to a first cell group (e.g., an MCG) using a resource that is based on control signaling. For example, a UE may receive or otherwise obtain first control messages scheduling a downlink transmission in the second cell group. The first control messages may indicate that a first UCI carrying feedback associated with the downlink transmission is to be transmitted to a second cell in the second cell group. For example, the second cell group may include a second cell (e.g., a PSCell) used for transmission of UCI associated with the second cell group. Additionally, the first control messages may indicate that a second UCI carrying the feedback associated with the downlink transmission is to be transmitted to a first cell in the first cell group. That is, the first cell group may include a first cell used for transmission of UCI associated with the first cell group. The UE may transmit or otherwise output UCI associated with the second cell group to the first cell in the first cell group and to the second cell in the second cell group. The UE may use a resource of the first cell that is based on the first control messages to transmit the UCI associated with the second cell group to the first cell in the first cell group. For example, the first control messages, and one or more additional control messages, may indicate a slot, a resource, or both in the first cell in which the UE is to transmit the UCI associated with the second cell group. These and other techniques are described in further detail with respect to the figures.

Aspects of the disclosure are initially described in the context of wireless communications systems. Aspects of the disclosure are also described in the context of slot diagrams and process flows. Aspects of the disclosure are further illustrated by and described with reference to apparatus diagrams, system diagrams, and flowcharts that relate to signaling for transmission of UCI in a CC group.

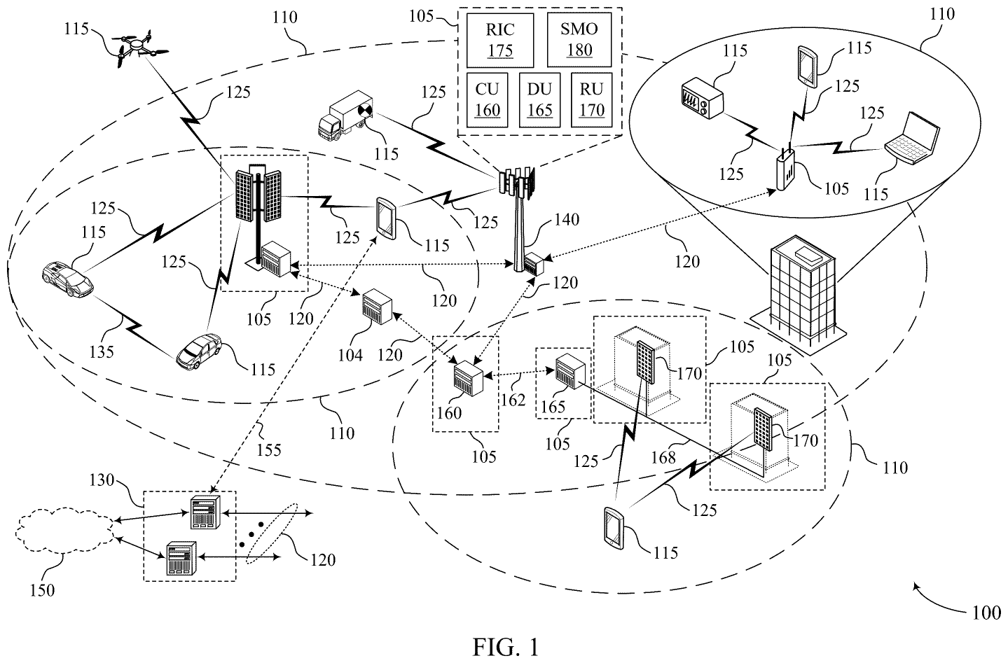

FIG. 1 shows an example of a wireless communications system 100 that supports signaling for transmission of UCI in a CC group in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support signaling for transmission of UCI in a CC group as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions.

Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple CCs.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a UE 115 may transmit UCI including feedback for a downlink transmission to multiple cells in different cell groups. For example, the UE 115 may receive one or more first control messages scheduling a downlink transmission in a first cell group (e.g., an SCG) including a first cell. The one or more first control messages may indicate that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group (e.g., a MCG). The UE 115 may transmit, to the first cell of the first cell group and in accordance with receiving the one or more first control messages, the first UCI carrying the feedback associated with the downlink transmission in the first cell group. Additionally, the UE 115 may transmit, to the second cell of the second cell group and using a resource of the second cell that is based on the one or more first control messages, the second UCI carrying the feedback associated with the downlink transmission in the first cell group. That is, the UE 115 may determine a resource to transmit the second UCI carrying the feedback based on the control messages that schedule the downlink transmission.

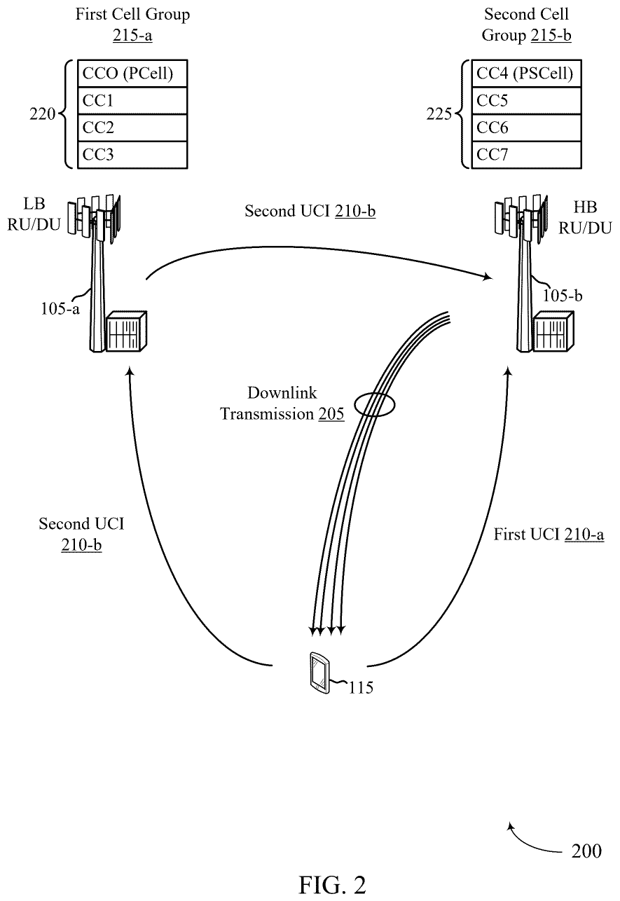

FIG. 2 shows an example of a wireless communications system 200 that supports signaling for transmission of UCI in a CC group in accordance with one or more aspects of the present disclosure. The wireless communications system 200 may implement aspects of wireless communications system 100. For example, the wireless communications system 200 may include a UE 115, a network entity 105-a, and a network entity 105-b, which may be examples of the corresponding devices described with reference to FIG. 1. In the example of FIG. 2, the network entity 105-a may be an example of or may support a first cell of a first cell group 215-a (e.g., an MCG), and the network entity 105-b may be an example of or may support a second cell of a second cell group 215-b (e.g., a SCG). While illustrated as being supported by different network entities 105, in some cases, the first cell group 215-a and the second cell group 215-b may be supported by the same network entity 105 and/or co-located network entities.

The UE 115 may be configured to communicate via multiple cell groups. In a first example, the UE 115 may communicate via DC. A DC configuration may include an MCG and one or more SCGs, where the MCG may have one or more cells and each SCG may have one or more cells. In a second example, the UE 115 may communicate via CA. A CA configuration may include a first cell group and a second cell group, where each of the first cell group and the second cell group may include one or more cells. In some aspects, each cell in a cell group may also be associated with a CC used for communications between the UE 115 and that cell. Accordingly, references to a cell and a CC may be used interchangeably.

In some aspects, the UE 115 configured for communications via multiple cells groups may include multiple PUCCH groups. For example, the UE 115 may be configured with two PUCCH groups in DC or CA configurations. For DC configurations, the PUCCH of CCs in the MCG may be transmitted on the PCell and the PUCCH of all CCs in the SCG(s) are sent on the PSCell (e.g., the PCell of the SCG).

For CA configurations, the PUCCH of cells within a cell group may be transmitted on the PSCell or PUCCH cell of that cell group (e.g., one PUCCH group). In other CA examples, two PUCCH groups may be configured for the UE 115, which may be based on the capability of the UE 115. For example, the UE 115 configured for CA communications may be configured with a primary PUCCH group including a PCell and one or more SCells (e.g., similar to the MCG in DC configurations) as well as a secondary PUCCH group that includes a PUCCH SCell as well as one or more SCells (e.g., similar to the SCG in DC configurations).

The PUCCH cell for a cell group may be configured as part of a physical downlink shared channel (PDSCH)-ServingCellConfig parameter. For example, the UE 115 may use this parameter to identify or otherwise determine the serving cell index for the PUCCH cell that carries PUCCH for this serving cell. That is, the PDSCH-ServingCellConfig parameter may carry or otherwise convey information that identifies the pucch-Cell ServCellIndex used by the UE 115 to determine the serving cell index (e.g., to identify the PUCCH cell for that cell group).

In some aspects, the uplink coverage area associated with multi-cell group configurations for the UE 115 may differ. For example, when the CA deployment is feasible, the cell groups may include collocated cells within a single or coordinated DU (e.g., intra-frequency CA) deployment or, otherwise, a non-collocated cell deployment may be used with a low-latency backhaul interface between the cells. In such examples, multiplexing uplink control information for all carriers (cells or CCs) may be dynamically performed on the anchor cell (e.g., PCell or PUCCH cell). This reduction of the downlink/uplink imbalance may rely on a low-band coverage layer for the uplink, as UCI may be carried on a cell (e.g., CC) in a lower band with more favorable propagation conditions.

When meeting the deployment requirements for CA (e.g., with single PUCCH group) is not feasible, some wireless networks may use a DC configuration (or multiple PUCCH groups with CA). For example, some wireless networks deployed for FR1 and FR2 that require aggregation for the UE 115 may use the DC configuration.

With DC (or multiple PUCCH groups with CA), the downlink coverage of each cell group may be limited by its own uplink coverage (e.g., as the uplink control is sent on a CC in the same cell group). In such examples, high downlink throughput of high-band spectrum cell deployments may be realized in favorable coverage regions (e.g., when uplink coverage of high-band spectrum is good enough). Accordingly, this may result in a need to enhance the uplink coverage in non-collocated deployment scenarios.

Accordingly, uplink coverage enhancements for CA or DC configurations may be needed (e.g., how to provide a low-band anchor in non-collocated/non-coordinated multi-carrier systems). This may include transmission of uplink feedback (e.g., HARQ information bits, RLC status PDU, and the like) for the high-band cell group on the low-band CC with a better or extended coverage. For example, the HARQ bits can be sent as a group acknowledgment (ACK)/negative acknowledgment (NACK) and protected with CRC. In such examples, resources may be semi-statically reserved for the high-band cell group on a low-band anchor cell (e.g., the PCell of the MCG in DC). However, the backhaul latency may be dependent on the deployment and the interface used (e.g., may be commonly assumed to be around 10 -20 ms). For such relatively large backhaul latency, increasing the quantity of HARQ processes to fill the scheduling gaps may not always be feasible (e.g., in high frequency bands with large SCS). For example, this may also impact buffering and HARQ management by the UE 115.

Accordingly, in some situations, the UE 115 may be configured with a first cell group 215-a that the UE 115 communicates with on a low-band DU/RU. This may be considered the MCG in a DC configuration or the first PUCCH group in a CA configuration with two PUCCH groups. The PUCCH cell for the first cell group 215-a may be the PCell (e.g., a first cell in the first cell group, in this example) that carries the uplink control (e.g., UCI) on PUCCH for all downlink CCs in this first cell group.

The UE 115 may also be configured with a second cell group 215-b that the UE 115 communicates with on a high-band DR/RU. This may be considered the SCG in a DC configuration or a second PUCCH group in a CA configuration with two PUCCH groups. The PUCCH cell (e.g., a second cell in this second cell group) for the second cell group 215-b may be the PSCell (e.g., in case of DC) or PUCCH SCell (e.g., in case of CA with two PUCCH cell groups), which carries the uplink control (e.g., UCI) on PUCCH for all downlink CCs in this second cell group. The uplink coverage for this PUCCH cell (e.g., the high-band cell, or second cell of the second cell group) may be limited.

Accordingly, in some examples, the UCIs that are not delay sensitive may be sent on the PCell (e.g., the first cell of the first cell group 215-a, which may be the low-band cell group) to free up resources on the second PUCCH cell (e.g., the second cell of the second cell group 215-b, which may be the high-band cell group) such that the delay sensitive UCIs may be sent directly to the high-band DU/RU. In some cases, the HARQ-ACK may be sent on both PUCCH cells (on both the high-band and the low-band cell group). This may achieve low latency opportunistically on the high-band cell group with a backup on the low-band cell group. In some aspects, this may include sending a compressed version or statistics (e.g., ratio of NACKs to total numbers of PDSCH receptions on the second cell group) of the HARQ-ACK on the PCell of the low-band cell group for the purpose of link adaptation by the high-band cell group, which is not delay sensitive as this is not used for HARQ retransmissions.

For example, the UE 115 may receive or otherwise obtain (and the network entity 105-a may transmit or otherwise output) signaling indicating a configuration for communications via a first cell group 215-a and a second cell group 215-b. The signaling may include RRC signaling or other signaling between the UE 115 and the network entity 105-a. The configuration for multi-cell group communications may include configuring the UE 115 for communications according to a DC scenario or a CA scenario. For example, the first cell group 215-a may be an MCG in a DC deployment scenario or may be a primary/first PUCCH group in a CA scenario with two PUCCH cell groups. The first cell group 215-a may include a first cell that may be the PCell for this cell group (e.g., carries uplink control on PUCCH for all downlink CCs in this cell group). For example, the first cell may be used for transmission (e.g., by the UE 115) of UCI associated with the first cell group. The network entity 105-a may be an example of the first cell in the first cell group 215-a in this example. For example, the first cell group 215-a may include one or more cells or CCs, such as a CC group 220 that includes CC0, CC1, CC2, and CC3, which may collectively be referred to as CC0-3.

The second cell group 215-b may be a SCG in the DC scenario or a second PUCCH group in the CA scenario with two PUCCH groups. The second cell group 215-b may include a second cell that may be the PSCell for the DC scenario or the PUCCH SCell in the CA scenario with two PUCCH groups (e.g., carries uplink control on PUCCH for all downlink CCs in this cell group). For example, the second cell may be used for transmission of UCI associated with the second cell group 215-b. The network entity 105-b may be an example of the second cell in the second cell group 215-b in this example. For example, the second cell group 215-b may include one or more cells or CCs, such as a CC group 225 that includes CC4, CC5, CC6, and CC7, which may collectively be referred to as CC4 -7.

In some aspects, the UE 115 may transmit or otherwise output UCI associated with the second cell group 215-b (e.g., UCI including feedback for a downlink transmission 205 from the network entity 105-b) to the first cell in the first cell group 215-a, to the second cell in the second cell group 215-b, or to both the first cell and the second cell. For example, the UE 115 may transmit first UCI 210-a to the second cell in the second cell group 215-b, second UCI 210-b to the first cell in the first cell group 215-a, or both. In some aspects, transmitting the UCI associated with the second cell group 215-b to the first cell, to the second cell, or to both the first cell and the second cell may be in accordance with a parameter associated with the UCI.

Accordingly, in some examples, the network entity 105-a may receive or otherwise obtain, the network entity 105-b may receive or otherwise obtain, or both network entities may receive or otherwise obtain the UCI associated with the second cell group 215-b from the UE 115. In an example where the network entity 105-a receives the UCI associated with the second cell group 215-b, the network entity 105-a may transmit or otherwise output the UCI (e.g., in full or partially, with or without decoding, processing, or performing other functions) to the network entity 105-b (e.g., via a backhaul interface).

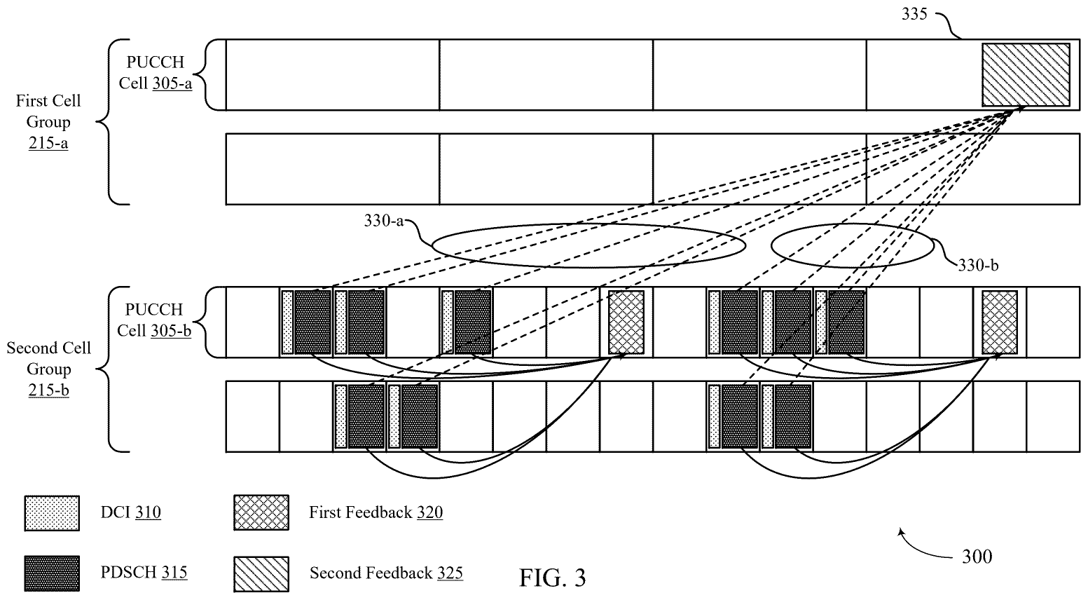

The UE 115 may transmit or otherwise output the first UCI 210-a, the second UCI 210-b or both on a resource that is based on one or more control messages. That is, the UE 115 may determine or otherwise identify a resource for transmission of the first UCI 210-a, the second UCI 210-b, or both based on control messages. The resource for transmission of the UCI(s) and the control messages may be described in greater detail elsewhere herein, including with reference to FIG. 3.

FIG. 3 shows an example of a slot diagram 300 that supports signaling for transmission of UCI in a CC group in accordance with one or more aspects of the present disclosure. The slot diagram 300 may implement or be implemented by various aspects of the wireless communications system, the wireless communications system 200, or both. For example, the slot diagram 300 may illustrate and describe communications between a UE and a first cell group 215-a and a second cell group 215-b, which may represent examples of corresponding devices as described with reference to FIGS. 1 and 2.

A wireless communications device, such as the UE 115 as described with reference to FIGS. 1 and 2, may transmit feedback associated with a downlink transmission. For example, the wireless communications device may receive control messages, such as a DCI 310, scheduling a downlink transmission, such as a PDSCH 315. The wireless communications device may receive the DCI 310 and the PDSCH on a second cell group 215-b. The wireless communications device may transmit feedback associated with the PDSCH 315. In the example of FIG. 3, the wireless communications device may transmit first feedback 320 on a PUCCH cell 305-b of a second cell group 215-b and second feedback 325 on a PUCCH cell 305-a of a first cell group 215-a. The first feedback 320 and the second feedback 325 may both correspond to or be for a same downlink transmission (e.g., the PDSCH 315) or a same set of multiple downlink transmissions. That is, the wireless communications device may transmit feedback for a downlink transmission received on a second cell group 215-b on cells of both the second cell group 215-b and a first cell group 215-a.

The wireless communications device may determine or otherwise identify a resource for transmission of the second feedback 325. For example, the wireless communications device may transmit the second feedback 325 on a resource that is based on control messages, such as the DCI 310. The resource may be an example of or correspond to a slot, a time resource, a frequency resource, or any combination thereof.

The wireless communications device may transmit the second feedback 325 on a slot 335 that is determined based on a slot offset indicator field in the DCI 310. For example, a slot offset indicator field in the DCI 310 (e.g., a scheduling DCI) may be used to indicate the slot 335. The DCI 310 may be an example of a DCI that schedules the PDSCH 315 on a CC of the second cell group 215-b, such as schedules the PDSCH 315 on the PUCCH cell 305-b. In some examples, the slot offset indicator field may include a value (e.g., a reserved value) that indicates that the second feedback 325 (e.g., ACK or NACK) is not to be transmitted on the first cell group 215-a. That is, the DCI 310 may dynamically indicate whether the wireless communications device is to transmit the second feedback 325 on the first cell group 215-a.

The slot offset indicator field may be separate from a slot offset indicator field that indicates a slot for the first feedback 320. That is, the DCI 310 may include a first slot offset indicator field that indicates a first slot offset associated with the first feedback 320 and a second slot offset indicator field that indicates a second slot offset associated with the second feedback 325. The first slot offset, the second slot offset, or both may be examples of k1 offset values. That is, the first slot offset, the second slot offset, or both may represent a quantity of slots between the PDSCH 315 and transmission of the respective feedback (e.g., the first feedback 320 or the second feedback 325). Alternatively, the second slot offset may be defined with respect to the slot of the first feedback 320. That is, the second slot offset may be a quantity of slots between a slot of the first feedback 320 (in the PUCCH cell 305-b) and transmission of the second feedback 325 (e.g., the slot 335 of the PUCCH cell 305-a).

In some examples, the wireless communications device may receive a control message prior to the DCI 310 that indicates a set of slot offset values. For example, the wireless communications device may receive one or more RRC messages indicating (e.g., may be RRC configured with) the set of (e.g., one or more) slot offset values. The DCI 310 may indicate or refer to a slot offset value of the set of slot offset values. In some examples, the set of slot offset values may be different than or separate from a set of slot offset values associated with the first feedback 320. That is, the wireless communications device may receive one or more RRC messages indicating a first set of slot offset values associated with the second cell group 215-b (e.g., the first feedback 320) and a second set of slot offset values associated with the first cell group 215-a (e.g., the second feedback 325). Additionally, or alternatively, the set of slot offset values may correspond to a DCI format. That is, the wireless communications device may receive one or more RRC messages indicating different sets of slot offset values associated with different DCI formats.

In examples in which the set of slot offset values include a single value (e.g., a set of one slot offset value), the DCI 310 may be absent of the slot offset indicator field indicating a slot offset for the second feedback 325. That is, because the RRC messages indicated a single slot offset value, the wireless communications device may apply, without additional signaling or indication(s) in the DCI 310, the slot offset for the second feedback 325 included in the RRC messages.

In the example of FIG. 3, the DCI 310 may indicate a first slot offset 330-a for the second feedback 325 of k1=2 relative to the first feedback 320. Additionally, the DCI 310 may indicate a second slot offset 330-b for the second feedback 325 of k1=0 relative to the first feedback 320. That is, the second feedback 325 may be 2 slots from the first instance of the first feedback 320 and 0 slots from (e.g., in a same slot as) the second instance of the first feedback 320. In the example of FIG. 3, a slot duration of slots in the first cell group 215-a may be longer than a slot duration of slots in the second cell group 215-b. For example, the slot durations between cell groups may vary based on the cell groups having different numerologies or bandwidths. In the example of FIG. 3, the first cell group 215-a may operate in a first frequency range (e.g., 30 kHz) while the second cell group 215-b may operate in a second frequency range (e.g., 120 kHz).

The wireless communications device may transmit the second feedback 325 on a slot 335 that is a next available uplink slot of a reference CC of the first cell group 215-a. The reference CC may be the PUCCH cell 305-a of the first cell group 215-a, a CC with a lowest index within the first cell group 215-a, or a CC with a lowest SCS within the first cell group 215-a.

The slot 335 may be “next” relative to (e.g., after) the PDSCH 315 slot, relative to (e.g., after) a fixed quantity of slots after the PDSCH 315 slot (e.g., an RRC-configured quantity of slots), or relative to (e.g., after or the same as) a slot of the first feedback 320. In other words, the wireless communications device may transmit the second feedback 325 on the slot 335, where the slot 335 is after the PDSCH 315.

Alternatively, the wireless communications device may receive one or more control messages (e.g., RRC messages) that indicate a quantity of slots after the PDSCH 315 slot, where the slot 335 is after the quantity of slots. Or, the wireless communications device may transmit the second feedback 325 on a same slot as or a slot following a slot in which the first feedback 320 is transmitted.

The slot 335 may be “available” based on a configuration, such as a semi-static TDD configuration or an RRC configuration. For example, the wireless communications device may receive an indication of a TDD configuration of the reference CC. The TDD configuration may be an example of a tdd-UL-DL-ConfigurationCommon, a tdd-UL-DL-ConfigurationDedicated, or the like. The TDD configuration may include a pattern of uplink symbols, flexible symbols, and downlink symbols. The slots with uplink or flexible symbols of the TDD configuration may be “available.” The wireless communications device may transmit the second feedback 325 in the slot 335 that is available in accordance with the TDD configuration (e.g., includes uplink or flexible symbols according to the TDD configuration).

Additionally, or alternatively, the wireless communications device may receive an indication of an RRC configuration that indicates a periodic pattern of available slots of the reference CC. That is, the wireless communications device may receive one or more RRC messages that include an indication of the periodic pattern of available slots of the reference CC. The RRC configuration may be associated or unassociated with the TDD configuration (e.g., a TDD pattern indicated by the TDD configuration). For example, a network entity, such as the network entity 105 as described with reference to FIGS. 1 and 2, may align the RRC configuration with the TDD pattern.

The wireless communications device may determine the slot 335 according to the slot offset indicator value or the next available uplink slot (e.g., determine whether to use the slot offset indicator value or the next available uplink slot to identify the slot 335) based on control signaling. For example, control signaling may identify whether the wireless communications device is to use the slot offset indicator value or the next available uplink slot to determine the slot 335 for transmission of the second feedback 325. The control signaling may include one or more RRC messages (e.g., an RRC configuration) or the DCI 310. For example, the DCI 310 (e.g., the scheduling DCI) may include a DCI format. A first DCI format (e.g., a non-fallback DCI, such as a format 1_1 or a format 1_2) may indicate that the slot 335 is defined according to the slot offset indicator field. A second DCI format (e.g., format 1_0 or fallback DCI format) may indicate that the slot 335 is defined according to the next available uplink slot. The second DCI format may not include the slot offset indicator field.

The wireless communications device may transmit the second feedback 325 on a resource that is based on control signaling. For example, the wireless communications device may transmit the second feedback 325 on a resource (e.g., a PUCCH resource) that is based on a PUCCH resource indicator (PRI) field in the DCI 310 (e.g., a scheduling DCI). The PRI field may be separate from a PRI field associated with the first feedback 320. That is, the DCI 310 may include a first PRI field associated with the first feedback 320 and a second PRI field associated with the second feedback 325. A value (e.g., a reserved value) in the PRI field may indicate that the second feedback 325 is not to be transmitted on the first cell group 215-a. That is, the DCI 310 may dynamically indicate whether the second feedback 325 is to be transmitted in the first cell group 215-a. Additionally, or alternatively, the resource may be based on a payload size of the second feedback 325.

The wireless communications device may receive one or more RRC messages indicating a list of PUCCH resources on the PUCCH cell 305-a of the first cell group 215-a. The list of resources may be configured for transmission of the second feedback 325 for the second cell group 215-b. Additionally, the list of resources may be separate from a list of resources on the PUCCH cell 305-a for the first cell group 215-a. That is, the wireless communications device may receive, separately, RRC messages indicating a first list of PUCCH resources on the PUCCH cell 305-a allocated for feedback associated with downlink transmissions on the second cell group 215-b and indicating a second list of PUCCH resources on the PUCCH cell 305-a allocated for feedback associated with downlink transmissions on the first cell group 215-a and one or more other uplink control messages. Additionally, or alternatively, the first list of PUCCH resources and the second list of PUCCH resources may be configured using different fields or information elements of RRC signaling.

The wireless communications device may transmit the second feedback 325 on a configured grant (CG)-physical uplink shared channel (PUSCH) that is configured or activated on a PUSCH of a CC of the first cell group 215-a. For example, the DCI 310 (e.g., a scheduling DCI that schedules a CC of the second cell group 215-b) may include an indication of a CG configuration identifier referring to a CC of the first cell group. The wireless communications device may use a next CG occasion on or after the slot 335 for transmission of the second feedback 325, where the slot 335 is based on the slot offset indicator field or the next available uplink slot. Thus, RRC signaling or other types of control signaling may configure the CG occasions, and the scheduling DCI may activate the configured CG occasions such that the second feedback may be transmitted on the next CG occasion.

The wireless communications device may construct a payload of the second feedback 325 based on a codebook type (e.g., a HARQ-ACK codebook type). In a first example, the wireless communications device may construct the payload based on a Type 3 or one-shot codebook. In such examples, the DCI 310 may include a field that triggers the Type 3 codebook. The field may be separate from or the same as a DCI field that triggers the Type 3 codebook for the first feedback 320. In examples in which the DCI 310 includes a single field that triggers the Type 3 codebook for both the first feedback 320 and the second feedback 325, the DCI 310 may indicate (e.g., via the single field) that the wireless communications device is to construct a payload of the first feedback 320 and a payload of the second feedback 325 based on the Type 3 codebook. Alternatively, in examples in which the DCI 310 includes separate fields that trigger the Type 3 codebook for the first feedback 320 and the second feedback 325, the DCI 310 may trigger the Type 3 codebook for the first feedback 320 and the second feedback 325 separately and independently (e.g., may only trigger one of the first feedback 320 or the second feedback 325, or separately trigger the first feedback 320 and the second feedback 325). The DCI 310 may indicate a set of HARQ process identifiers or CCs for which the Type 3 codebook for the second feedback 325 is triggered. The DCI 310, in such examples, may be a scheduling DCI (e.g., that schedules a CC of the second cell group 215-b) or a non-scheduling DCI (e.g., with reserved frequency domain resource allocation (FDRA) field value without scheduling a downlink transmission). The wireless communications device may construct the codebook based on the set of HARQ process identifiers, the set of CCs, or both of the second cell group 215-b.

In a second example, the wireless communications device may construct the payload based on a Type 2 or dynamic codebook. For example, the wireless communications device may construct the codebook based on an order of received DCIs in corresponding physical downlink control channel (PDCCH) monitoring occasions and values of downlink assignment index (DAI) fields indicated in each DCI. A DAI field in the DCI 310 may be separate from or the same as a DAI field for the second feedback 325. For example, the DCI 310 may include a DAI field indicating a DAI for the first feedback 320 and the second feedback 325. Alternatively, the DCI 310 may include a first DAI field indicating a first DAI for the first feedback 320 and a second DAI field indicating a second DAI for the second feedback 325, where the first DAI and the second DAI are the same or different.

In examples in which the DCI 310 includes a single DAI field for the first feedback 320 and the second feedback 325, a codebook (e.g., a HARQ-ACK codebook or payload) may be the same for the first feedback 320 and the second feedback 325. In such examples, the wireless communications device may construct a single codebook for both the first feedback 320 and the second feedback 325 (e.g., only one codebook construction is needed though the feedback is transmitted on different CCs).

Alternatively, in examples in which the DCI 310 includes separate DAI fields for the first feedback 320 and the second feedback 325, a codebook (e.g., a HARQ-ACK codebook or payload) may be the same or different for the first feedback 320 and the second feedback 325. For example, the first feedback 320 may include 6 ACK or NACK bits for 6 PDSCHs on the second cell group 215-b, and the second feedback 325 may include 10 ACK or NACK bits for 10 PDSCHs on the second cell group 215-b.

In a third example, the wireless communications device may construct the payload based on a Type 1 or semi-static codebook. For example, the codebook may be constructed based on a set of candidate PDSCH receptions derived from a set of k1 slot offset values. In other words, the wireless communications device may construct the codebook based on the set of PDSCH receptions, where the set of PDSCH receptions are based on respective k1 slot offset values of a set of k1 slot offset values. The set of k1 slot offset values may be included in control signaling (e.g., RRC signaling or messages). Additionally, the set of k1 slot offset values may be the same or different than a set of k1 slot offset values of the first feedback 320 (e.g., which may result in a same or different codebook between the first feedback 320 and the second feedback 325).

A type of the first feedback 320 and the second feedback 325 may be the same or different. For example, the wireless communications device may construct a payload for the first feedback 320 according to a codebook type that is different than a codebook type used to construct a payload for the second feedback 325. Additionally, or alternatively, the types may be configured separately. For example, the wireless communications device may receive separate RRC configurations that indicate codebook types for the first feedback 320 and the second feedback 325.

The wireless communications device may transmit the first feedback 320, the second feedback 325, or both using a transmit power that is based on one or more transmit power control (TPC) commands. That is, in examples in which the second feedback 325 is transmitted on a PUCCH resource of the PUCCH cell 305-a of the first cell group 215-a (e.g., a PCell), a closed-loop power control may be based on the one or more TPC commands. In a first example, the transmit power used to transmit the second feedback 325 may be based on a TPC command of the DCI 310 (e.g., a scheduling DCI that schedules a CC of the second cell group 215-b). The DCI 310 may include a first TPC command that indicates a transmit power for the first feedback 320 and a second TPC command that indicates a transmit power for the second feedback. In other words, the DCI 310 may include separate TPC commands for the first feedback 320 and the second feedback 325. As an example, the DCI 310 may indicate a TPC of −1 dB for the PUCCH of the second cell group 215-b (e.g., for the first feedback 320) and a TPC of +3 dB for the PUCCH of the first cell group 215-a (e.g., for the second feedback 325).

In a second example, the transmit power used to transmit the second feedback 325 may be based on a TPC command that is applied to both the first feedback 320 and the second feedback 325. For example, the DCI 310 may include a TPC command that includes a transmit power associated with the PUCCH of the second cell group 215-b as well as the first cell group 215-a. In the first example and in the second example, the DCI 310 may not include additional overhead (e.g., for indicating the separate TPC).

In a third example, the TPC used to transmit the second feedback 325 may be based on a TPC command that is included in one or more DCIs that schedule downlink transmissions (e.g., PDSCHs) on the first cell group 215-a. For example, the wireless communications device may receive one or more DCIs that schedule a CC on the first cell group 215-a, where the one or more DCIs include a TPC command that indicates a transmit power for PUCCH on the first cell group 215-a. In such examples, the DCI 310 may not impact the closed loop power control of the PUCCH of the first cell group 215-a. That is, even though the DCI 310 schedules PUCCH on the PUCCH cell 305-a of the first cell group 215-a, the closed loop power control may be based on the DCIs that schedule a CC (e.g., schedule PDSCHs on a CC) on the first cell group 215-a.

The wireless communications device may determine whether to multiplex the second feedback 325 with other uplink messages transmitted on the CC of the first cell group 215-a. For example, when the second feedback 325 is scheduled on the PUCCH cell 305-a of the first cell group 215-a (e.g., the PCell), the wireless communications device may determine whether the PUCCH including the second feedback 325 is multiplexed with other UCIs (e.g., HARQ-ACK, scheduling request, or channel state information (CSI) for the first cell group) or PUSCHs transmitted on a CC of the first cell group 215-a. The wireless communications device may multiplex or refrain from multiplexing the second feedback based on coordination between a high-band DU/RU (e.g., the second cell group 215-b or SCG) and a low-band DU/RU (e.g., the first cell group 215-a or the MCG), whether the presence or payload size of the second feedback 325 is known to the low-band DU/RU, or both. In some examples, the wireless communications device may refrain from multiplexing in examples in which UCIs or PUSCHs on the low-band DU/RU are delay-sensitive (e.g., require faster processing) and the low-band DU/RU does not know the presence or payload size of the second feedback 325 (e.g., due to backhaul latency between the high-band DU/RU that schedules the second feedback 325 and the low-band DU/RU that needs to decode it).

The wireless communications device may refrain from multiplexing the second feedback 325 with the PUSCHs or PUCCHs of the first cell group 215-a. For example, the wireless communications device may refrain from multiplexing (e.g., not multiplex) in examples in which the resources reserved (e.g., semi-statically) for the second feedback 325 are time division multiplexed with PUSCHs or PUCCHs of the first cell group 215-a (e.g., the low-band DU/RU avoids scheduling PUSCH or UCI that overlaps with these resources). Additionally, or alternatively, the wireless communications device may refrain from multiplexing in examples in which the wireless communications device transmits the second feedback 325 and PUSCHs or PUCCHs of the first cell group 215-a simultaneously as two different channels (e.g., possible for inter-band CA within the first cell group 215-a). Or, the wireless communications device may refrain from multiplexing in examples in which the wireless communications device drops either the second feedback 325 or the PUSCHs or PUCCHs of the first cell group 215-a when they overlap (e.g., based on some priority dropping rule).

The wireless communications device may multiplex the second feedback 325 with the PUSCHs or PUCCHs of the first cell group 215-a. For example, the wireless communications device may multiplex in examples in which the second feedback 325 and the PUSCHs or PUCCHs of the first cell group 215-a overlap (e.g., as if the second feedback 325 is a regular UCI).

The wireless communications device may perform multiplexing based on a content of a PUSCH or PUCCH that overlaps with the second feedback 325. In examples in which the overlap is with delay sensitive PUSCHs or PUCCHs (e.g., HARQ-ACK for the first cell group) of the first cell group 215-a, the wireless communications device may refrain from multiplexing. Alternatively, in examples in which the overlap is with non-delay sensitive PUSCHs or PUCCHs (e.g., CSI for the first cell group) of the first cell group 215-a, the wireless communications device may multiplex.

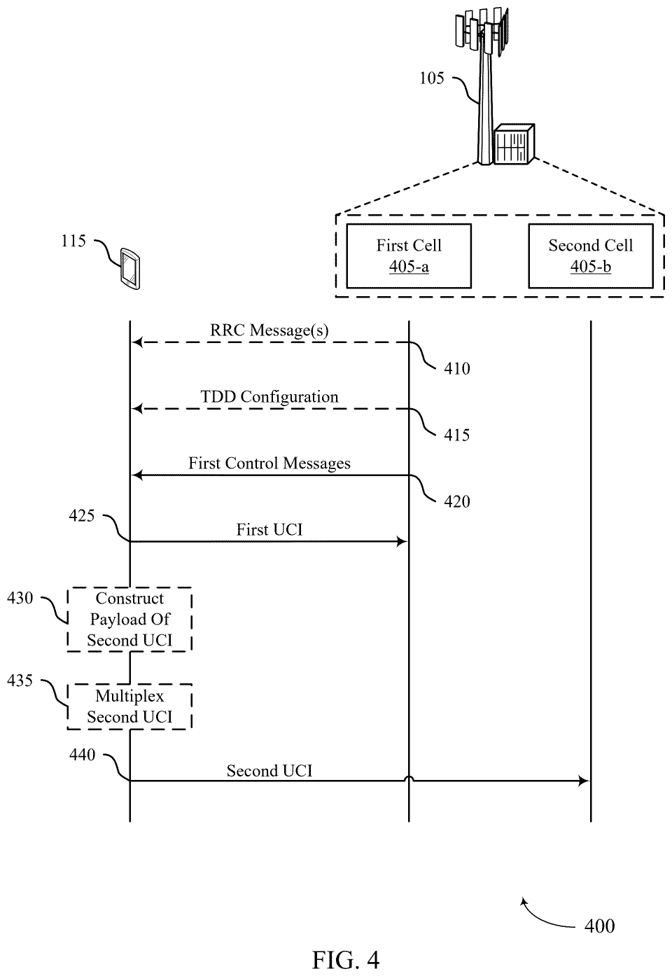

FIG. 4 shows an example of a process flow 400 that supports signaling for transmission of UCI in a CC group in accordance with one or more aspects of the present disclosure. The process flow 400 may implement or be implemented by aspects of the wireless communications system 100, the wireless communications system 200, the slot diagram 300, or any combination thereof. For example, the process flow 400 may include a UE 115, a first cell 405-a, a second cell 405-b, and a network entity 105, which may be examples of corresponding devices as described with reference to FIG. 1-3.

Alternative examples of the following may be implemented, where some operations are performed in a different order than described or are not performed at all. In some cases, operations may include additional features not mentioned below, or further operations may be added. Although the UE 115, the first cell 405-a, the second cell 405-b, and the network entity 105 are shown performing the operations of the process flow 400, some aspects of some operations may also be performed by one or more other wireless devices.

In the example of FIG. 4, the first cell 405-a and the second cell 405-b may be collocated (e.g., both located at the network entity 105) or non-collocated. That is, the network entity 105 may support or otherwise include both the first cell 405-a and the second cell 405-b. Alternatively, the first cell 405-a and the second cell 405-b may be associated with different network entities, such as the network entity 105-a and the network entity 105-b as described with reference to FIG. 2. Any of the operations at 410 through 440 may be understood to be performed by the network entity 105 (e.g., via the first cell 405-a and the second cell 405-b) or via separate, different network entities.

The first cell 405-a may be an example of a cell of an SCG, such as a PSCell. For example, the first cell 405-a may be an example of the PUCCH cell 305-b of the second cell group 215-b as described with reference to FIG. 3. The second cell 405-b may be an example of a cell of an MCG, such as a PCell. For example, the second cell 405-b may be an example of the PUCCH cell 305-a of the first cell group 215-a.

At 410, the UE 115 may receive one or more RRC messages from the first cell 405-a. For example, the UE 115 may receive, or the first cell 405-a may output, one or more RRC messages that include information associated with a resource. The information may include an indication of multiple slot offsets (e.g., k1 values), an indication of a periodic pattern, an indication of multiple PUCCH resources allocated for transmission of feedback associated with the first cell group in the second cell 405-b, an indication of one or more codebook types, or any combination thereof.

At 415, the UE 115 may receive a TDD configuration from the first cell 405-a. For example, the UE 115 may receive, or the first cell 405-a may output, an indication of a semi-static TDD configuration of a reference CC. The semi-static TDD configuration may be an example of the TDD configuration as described with reference to FIG. 3.

At 420, the UE 115 may receive first control messages from the first cell 405-a. For example, the UE 115 may receive, or the first cell 405-a may output, one or more first control messages scheduling a downlink transmission in a first cell group including the first cell 405-a. The one or more first control messages may be received from a high-band RU/DU of the network entity 105. The one or more first control messages may indicate that a first UCI carrying feedback associated with the downlink transmission in the first cell group is to be transmitted to the first cell 405-a in the first cell group and that a second UCI carrying the feedback associated with the downlink transmission in the first cell group is to be transmitted to a second cell 405-b of a second cell group. The first UCI and the second UCI may be examples of the first UCI 210-a and the second UCI 210-b, respectively, as described with reference to FIG. 4.

The one or more first control messages may include information associated with the resource. For example, the one or more first control messages may include a first slot offset indicator field (e.g., a first quantity of slots between the downlink transmission and the first UCI), a second slot offset indicator field (e.g., a second quantity of slots between the downlink transmission and the second UCI or between the first UCI and the second UCI), a first PRI field (e.g., associated with the first UCI), a second PRI field (e.g., associated with the second UCI), a CG configuration identifier, a field indicative of a codebook (e.g., a one-shot codebook), HARQ process identifiers, CC identifiers, DAI fields, or any combination thereof.

At 425, the UE 115 may transmit a first UCI to the first cell 405-a. For example, the UE 115 may transmit, or the first cell 405-a may obtain, in accordance with the one or more first control messages at 420, the first UCI carrying the feedback associated with the downlink transmission in the first cell group. The UE 115 may transmit the first UCI using a transmit power that is based on a first TPC command of a first DCI that schedules the downlink transmission in the first cell group.

At 430, the UE 115 may construct a payload of the second UCI. That is, the UE 115 may construct a payload of the second UCI based on a codebook that is indicated in the one or more first control messages. For example, the feedback of the second UCI may be based on a semi-static codebook (e.g., Type 1) in accordance with a set of PDSCH receptions that are based on the multiple slot offsets indicated at 410. For example, the UE 115 may use a Type 1 or semi-static codebook to construct the payload of the second UCI. Alternatively, the UE 115 may use a Type 3 codebook to construct the payload of the second UCI. That is, the feedback of the second UCI may be based on a one-shot codebook in accordance with the one or more first control messages including a field indicative of the one-shot codebook. In another example, the UE 115 may use a Type 2 codebook to construct the payload of the second UCI. That is, the feedback of the second UCI may be based on a dynamic codebook in accordance with the one or more first control messages including one or more DAI fields. The one or more DAI fields may include a first DAI field associated with the first UCI, a second DAI field associated with the second UCI, or a third DAI field associated with both the first UCI and the second UCI.

At 435, the UE 115 may multiplex the second UCI. For example, the UE 115 may transmit the second UCI to the second cell 405-b of the second cell group via a resource that is time division multiplexed with a second resource of the second cell 405-b or via a resource that is on a first channel of the second cell 405-b that includes a second channel carrying information for the second cell group.

In some examples, prior to multiplexing the second UCI, the UE 115 may determine whether to multiplex the second UCI with information for the second cell group based on the resource that is to carry the second UCI at least partially overlapping with a second resource that is to carry the information for the second cell group. The UE 115 may determine to multiplex the second UCI with the information when the information is not second feedback associated with a downlink transmission in the second cell group. Alternatively, the UE 115 may determine to transmit the second UCI separate from the information when the information comprises the second feedback associated with the downlink transmission in the second cell group.

In some examples, the UE 115 may refrain from transmitting information for the second cell group. For example, the UE 115 may refrain from transmitting the information for the second cell group based on the resource overlapping with a portion of a second resource scheduling for carrying the information for the second cell group. Additionally, or alternatively, the UE 115 may multiplex the second UCI with the information for the second cell group based on the resource that is to carry the feedback at least partially overlapping with a second resource that is to carry the information for the second cell group.

At 440, the UE 115 may transmit a second UCI to the second cell 405-b (e.g., the low-band RU/DU of the network entity 105). For example, the UE 115 may transmit, or the second cell 405-b of the second cell group may obtain, using a resource of the second cell 405-b that is based on the one or more first control messages, the second UCI carrying the feedback associated with the downlink transmission in the first cell group. The resource may be based on the one or more first control messages, the RRC messages, the TDD configuration, or any combination thereof.

In examples in which the one or more first control messages include a first slot offset indicator field and a second slot offset indicator field, the resource of the second cell 405-b may be a slot that is based on the second slot offset indicator field.

The first slot offset indicator field may indicate a first quantity of slots between the downlink transmission and the first UCI, and the second slot offset indicator field may indicate a second quantity of slots between the downlink transmission and the second UCI or between the first UCI and the second UCI. The second quantity of slots may be an example of the first slot offset 330-a and the second slot offset 330-b as described with reference to FIG. 3

Alternatively, the resource may be a first available uplink slot of a reference CC of the second cell group. For example, the first available uplink slot may occur after a first slot in which the downlink transmission is received by the UE 115, after a quantity of slots after the first slot, or in a second slot in which the first UCI is transmitted by the UE 115. The first available uplink slot may include one or more uplink symbols, one or more flexible symbols, or both that are based on the TDD configuration received at 415. Or, the first available uplink slot may be defined by the periodic pattern indicated by the RRC messages received at 410. In such examples, the reference CC may include a PUCCH cell of the second cell group (e.g., the PUCCH cell 305-a), a CC having a lowest index within the second cell group, or a CC with a lowest SCS within the second cell group.

The resource of the second cell 405-b may be a slot that is based on a slot offset indicator or a first available uplink slot of the reference CC in accordance with an RRC configuration or a format of the one or more first control messages (e.g., a DCI format). That is, the UE 115 may determine the resource based on the slot offset indicator or as the first available uplink slot of the reference CC depending on the RRC configuration or format of the first control messages.

The resource may be based on a second PRI field included in the one or more first control messages that is associated with the second UCI. That is, in examples in which the one or more first control messages include a first PRI field associated with the first UCI and a second PRI field associated with the second UCI, the resource may be based on the second PRI field. The PRI fields may be examples of the PRI fields as described with reference to FIG. 3.

The resource may be based on a payload size of the second UCI.

Additionally, or alternatively, the resource may be one of multiple PUCCH resources that are indicated by the RRC messages at 410. That is, in examples in which the one or more RRC messages indicate multiple PUCCH resources in the second cell allocated for transmission of the second UCI carrying the feedback associated with the downlink transmission in the first cell group, the resource may be one of the multiple PUCCH resources.

In yet another example, the resource may be included in a CG-PUSCH of the second cell group. That is, in examples in which the one or more first control messages include a CG configuration identifier that references the second cell group, the resource may be included in the CG-PUSCH of the second cell group based on the one or more first control messages including the CG configuration identifier. The CG-PUSCH carrying the second UCI may be from multiple CG-PUSCH occasions. In such examples, the CG-PUSCH may occur on or after a slot that is based on the one or more first control messages.

The UE 115 may transmit the second UCI using a transmit power that is based on a first TPC command of the first DCI that schedules the downlink transmission in the first cell group. Additionally, or alternatively, the UE 115 may transmit the second UCI using a transmit power that is based on a first TPC of first DCI received in the second cell group.

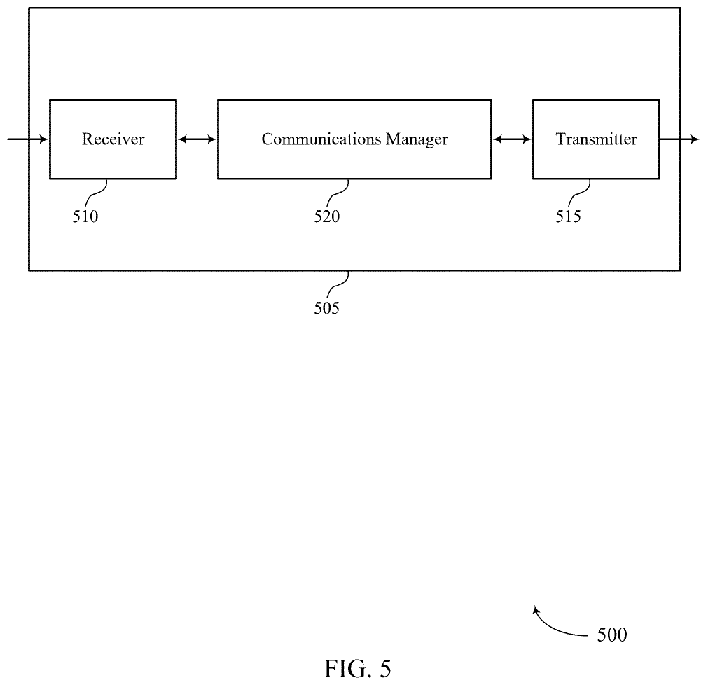

FIG. 5 shows a block diagram 500 of a device 505 that supports signaling for transmission of UCI in a CC group in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques.

Each of these components may be in communication with one another (e.g., via one or more buses).

The receiver 510 may provide a means for receiving information such as packets, user data, control information, or any combination thereof associated with various information channels (e.g., control channels, data channels, information channels related to signaling for transmission of UCI in a CC group). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to signaling for transmission of UCI in a CC group). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of signaling for transmission of UCI in a CC group as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group. The communications manager 520 is capable of, configured to, or operable to support a means for transmitting, to the first cell of the first cell group in accordance with receiving the one or more first control messages, the first UCI carrying the feedback associated with the downlink transmission in the first cell group. The communications manager 520 is capable of, configured to, or operable to support a means for transmitting, to the second cell of the second cell group and using a resource of the second cell that is based on the one or more first control messages, the second UCI carrying the feedback associated with the downlink transmission in the first cell group.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

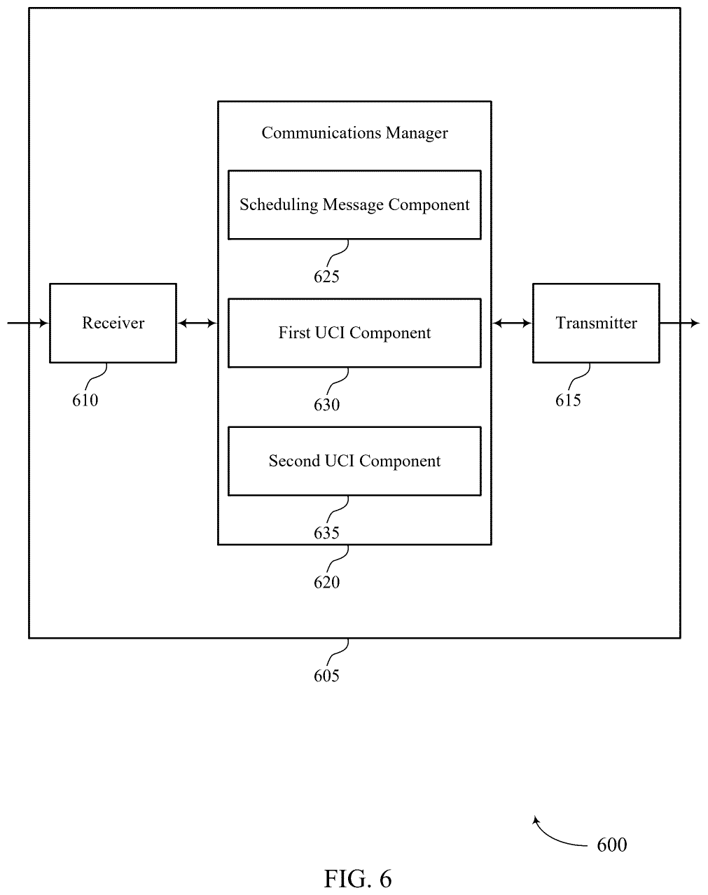

FIG. 6 shows a block diagram 600 of a device 605 that supports signaling for transmission of UCI in a CC group in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling for transmission of UCI in a CC group). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling for transmission of UCI in a CC group). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of signaling for transmission of UCI in a CC group as described herein. For example, the communications manager 620 may include a scheduling message component 625, a first UCI component 630, a second UCI component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The scheduling message component 625 is capable of, configured to, or operable to support a means for receiving one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group. The first UCI component 630 is capable of, configured to, or operable to support a means for transmitting, to the first cell of the first cell group in accordance with receiving the one or more first control messages, the first UCI carrying the feedback associated with the downlink transmission in the first cell group. The second UCI component 635 is capable of, configured to, or operable to support a means for transmitting, to the second cell of the second cell group and using a resource of the second cell that is based on the one or more first control messages, the second UCI carrying the feedback associated with the downlink transmission in the first cell group.

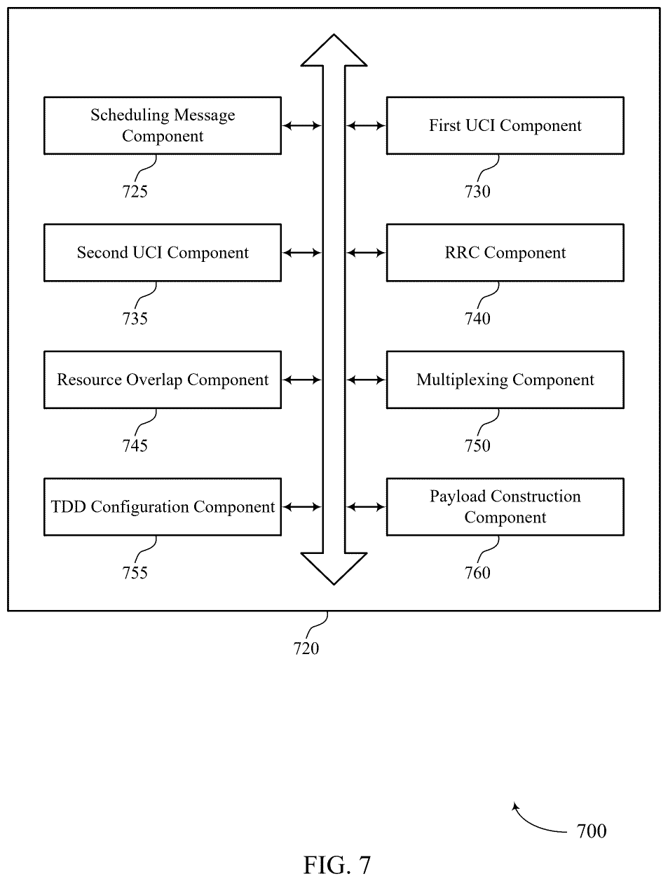

FIG. 7 shows a block diagram 700 of a communications manager 720 that supports signaling for transmission of UCI in a CC group in accordance with one or more aspects of the present disclosure. The communications manager 720 may be an example of aspects of a communications manager 520, a communications manager 620, or both, as described herein. The communications manager 720, or various components thereof, may be an example of means for performing various aspects of signaling for transmission of UCI in a CC group as described herein. For example, the communications manager 720 may include a scheduling message component 725, a first UCI component 730, a second UCI component 735, an RRC component 740, a resource overlap component 745, a multiplexing component 750, a TDD configuration component 755, a payload construction component 760, or any combination thereof.

Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The scheduling message component 725 is capable of, configured to, or operable to support a means for receiving one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group. The first UCI component 730 is capable of, configured to, or operable to support a means for transmitting, to the first cell of the first cell group in accordance with receiving the one or more first control messages, the first UCI carrying the feedback associated with the downlink transmission in the first cell group. The second UCI component 735 is capable of, configured to, or operable to support a means for transmitting, to the second cell of the second cell group and using a resource of the second cell that is based on the one or more first control messages, the second UCI carrying the feedback associated with the downlink transmission in the first cell group.

In some examples, the first slot offset indicator field indicates a first quantity of slots between the downlink transmission and the first UCI, the second slot offset indicator field indicates a second quantity of slots between the downlink transmission and the second UCI or between the first UCI and the second UCI, and the resource of the second cell includes a slot that is based on the second slot offset indicator field.

In some examples, the RRC component 740 is capable of, configured to, or operable to support a means for receiving an RRC message including an indication of a set of multiple slot offsets, where the second quantity of slots is one of the set of multiple slot offsets.

In some examples, the payload construction component 760 is capable of, configured to, or operable to support a means for constructing a payload of the second UCI based on a semi-static codebook in accordance with a set of candidate PDSCH receptions that are based on the set of multiple slot offsets.

In some examples, the resource includes a first available uplink slot of a reference CC of the second cell group.

In some examples, the first available uplink slot occurs after a first slot in which downlink transmission is received by the UE, after a quantity of slots after the first slot, or after a second slot in which the first UCI is transmitted by the UE.

In some examples, the TDD configuration component 755 is capable of, configured to, or operable to support a means for receiving an indication of a semi-static TDD configuration of the reference CC, where the first available uplink slot includes one or more uplink symbols, one or more flexible symbols, or both based on the semi-static TDD configuration.

In some examples, the RRC component 740 is capable of, configured to, or operable to support a means for receiving one or more RRC messages including an indication of a periodic pattern, where the periodic pattern includes the first available uplink slot.

In some examples, the reference CC includes a PUCCH cell of the second cell group, a CC having a lowest index within the second cell group, or a CC with a lowest subcarrier spacing within the second cell group.

In some examples, the resource includes a slot that is based on a slot offset indicator or a first available uplink slot of a reference CC in accordance with an RRC configuration or a format of the one or more first control messages.

In some examples, the one or more first control messages include a first PRI field associated with the first UCI and a second PRI field associated with the second UCI. In some examples, the resource is based on the second PRI field.

In some examples, the resource is based on a payload size of the second UCI.

In some examples, the RRC component 740 is capable of, configured to, or operable to support a means for receiving one or more RRC messages indicating a first set of multiple PUCCH resources in the second cell allocated for transmission of the second UCI carrying the feedback associated with the downlink transmission in the first cell group, where the resource is one of the set of multiple PUCCH resources.

In some examples, the resource is included in a CG-PUSCH of the second cell group.

In some examples, the one or more first control messages further include a CG configuration identifier that references the second cell group. In some examples, the resource is included in CG-PUSCH based on the CG configuration identifier.

In some examples, the CG-PUSCH carrying the second UCI is from a set of multiple CG-PUSCH occasions. In some examples, the CG-PUSCH occurs on or after a slot that is based on the one or more first control messages.

In some examples, the feedback of the second UCI is based on a one-shot codebook in accordance with the one or more first control messages including a field indicative of the one-shot codebook.

In some examples, the one or more first control messages indicate one or more HARQ process identifiers, CCs, or both for which the one-shot codebook is configured for the feedback of the second UCI.

In some examples, the feedback of the second UCI is based on a dynamic codebook in accordance with the one or more first control messages including one or more DAI fields.

In some examples, the one or more DAI fields include a first DAI field associated with the first UCI, a second DAI field associated with the second UCI, or a third DAI field associated with the first UCI and the second UCI.

In some examples, the RRC component 740 is capable of, configured to, or operable to support a means for receiving a first RRC message indicating a first codebook type for the feedback of the first UCI. In some examples, the RRC component 740 is capable of, configured to, or operable to support a means for receiving a second RRC message separate from the first RRC message indicating a second codebook type for the feedback of the second UCI.

In some examples, to support transmitting the second UCI, the second UCI component 735 is capable of, configured to, or operable to support a means for transmitting the second UCI using a transmit power that is based on a first TPC command of first downlink control information that schedules the downlink transmission in the first cell group.

In some examples, to support transmitting the first UCI, the first UCI component 730 is capable of, configured to, or operable to support a means for transmitting the first UCI using a transmit power that is based on the first TPC command of the first downlink control information that schedules the downlink transmission in the first cell group.

In some examples, to support transmitting the second UCI, the second UCI component 735 is capable of, configured to, or operable to support a means for transmitting the second UCI using a transmit power that is based on a first TPC command of first downlink control information received in the second cell group.

In some examples, the second UCI component 735 is capable of, configured to, or operable to support a means for transmitting the second UCI to the second cell of the second cell group via the resource that is time-division multiplexed with a second resource of the second cell or via the resource that is on a first channel of the second cell that includes a second channel carrying information for the second cell group.

In some examples, the resource overlap component 745 is capable of, configured to, or operable to support a means for refraining from transmitting information for the second cell group based on the resource overlapping with at least a portion of a second resource scheduling for carrying the information for the second cell group.

In some examples, the multiplexing component 750 is capable of, configured to, or operable to support a means for multiplexing the second UCI with information for the second cell group based on the resource that is to carry the feedback at least partially overlapping with a second resource that is to carry the information for the second cell group.

In some examples, the multiplexing component 750 is capable of, configured to, or operable to support a means for determining whether to multiplex the second UCI with information for the second cell group based on the resource that is to carry the second UCI at least partially overlapping with a second resource that is to carry the information for the second cell group, where the UE determines to multiplex the second UCI with the information when the information is not second feedback associated with a downlink transmission in the second cell group, and where the UE determines to transmit the second UCI separate from the information when the information includes the second feedback associated with the downlink transmission in the second cell group.

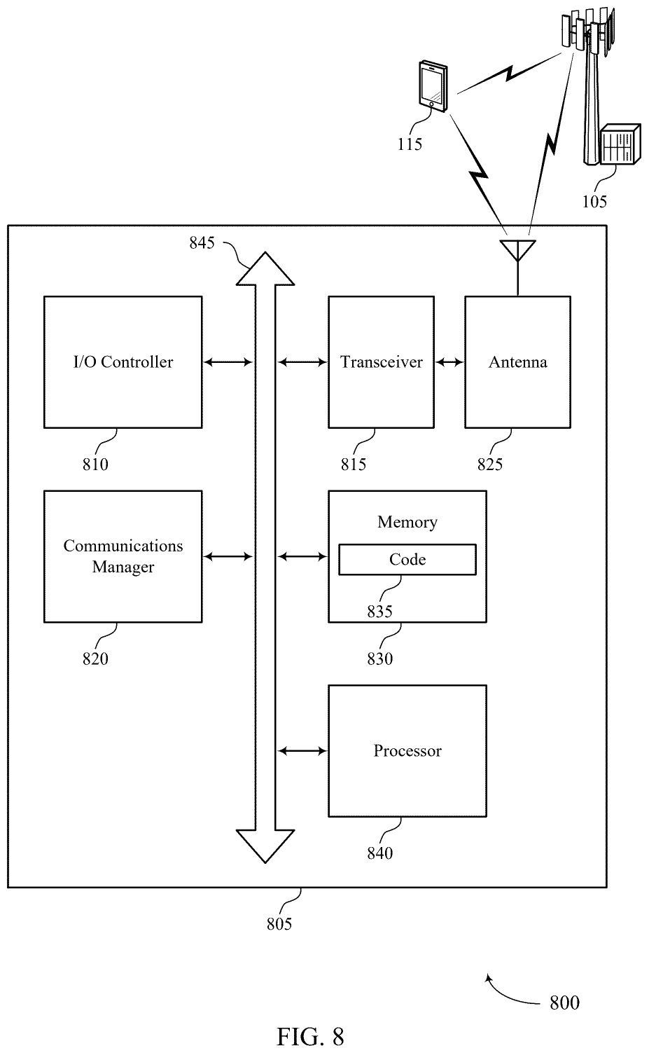

FIG. 8 shows a diagram of a system 800 including a device 805 that supports signaling for transmission of UCI in a CC group in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting signaling for transmission of UCI in a CC group). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group. The communications manager 820 is capable of, configured to, or operable to support a means for transmitting, to the first cell of the first cell group in accordance with receiving the one or more first control messages, the first UCI carrying the feedback associated with the downlink transmission in the first cell group. The communications manager 820 is capable of, configured to, or operable to support a means for transmitting, to the second cell of the second cell group and using a resource of the second cell that is based on the one or more first control messages, the second UCI carrying the feedback associated with the downlink transmission in the first cell group.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of signaling for transmission of UCI in a CC group as described herein, or the at least one processor 840 and the at least one memory 830 may be otherwise configured to, individually or collectively, perform or support such operations.

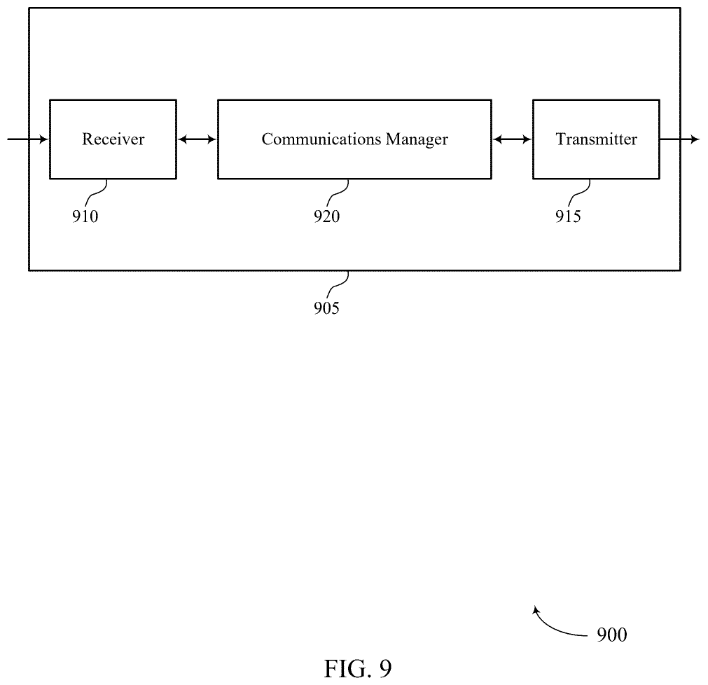

FIG. 9 shows a block diagram 900 of a device 905 that supports signaling for transmission of UCI in a CC group in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques.

Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem. As used herein, “outputting” and “obtaining” may refer to transmitting or receiving, respectively, (e.g., over the air) and/or transmitting to or receiving from another module or component within the network entity or to another aspect of the network entity.

The communications manager 920, the receiver 910, the transmitter 915, or various combinations or components thereof may be examples of means for performing various aspects of signaling for transmission of UCI in a CC group as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group. The communications manager 920 is capable of, configured to, or operable to support a means for obtaining, via the first cell of the first cell group in accordance with the one or more first control messages, the first UCI carrying the feedback associated with the downlink transmission in the first cell group. The communications manager 920 is capable of, configured to, or operable to support a means for obtaining, via the second cell of the second cell group and a resource of the second cell that is based on the one or more first control messages, the second UCI carrying the feedback associated with the downlink transmission in the first cell group.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

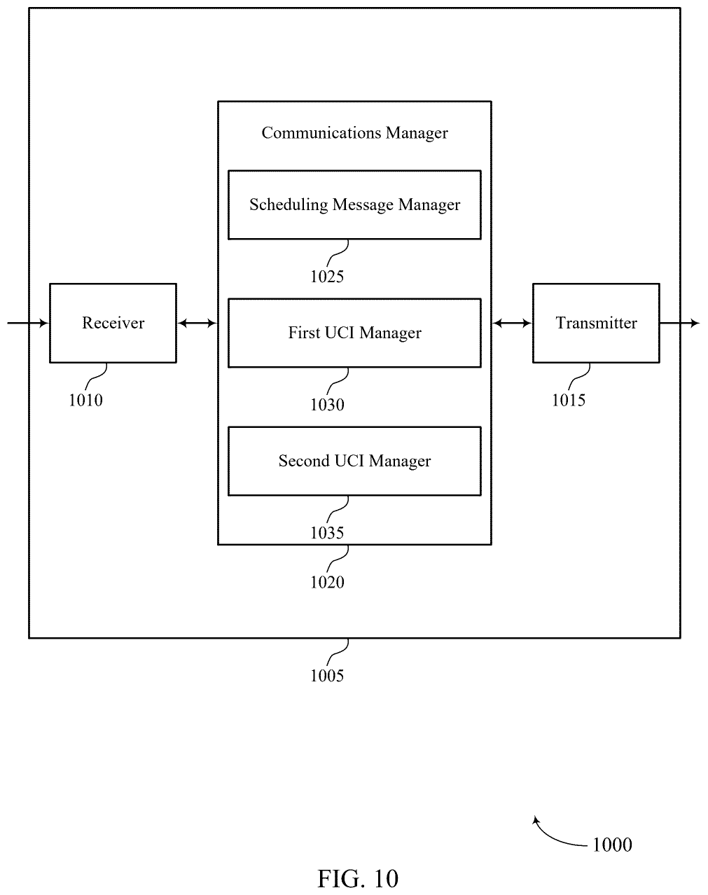

FIG. 10 shows a block diagram 1000 of a device 1005 that supports signaling for transmission of UCI in a CC group in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of signaling for transmission of UCI in a CC group as described herein. For example, the communications manager 1020 may include a scheduling message manager 1025, a first UCI manager 1030, a second UCI manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The scheduling message manager 1025 is capable of, configured to, or operable to support a means for outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group. The first UCI manager 1030 is capable of, configured to, or operable to support a means for obtaining, via the first cell of the first cell group in accordance with the one or more first control messages, the first UCI carrying the feedback associated with the downlink transmission in the first cell group. The second UCI manager 1035 is capable of, configured to, or operable to support a means for obtaining, via the second cell of the second cell group and a resource of the second cell that is based on the one or more first control messages, the second UCI carrying the feedback associated with the downlink transmission in the first cell group.

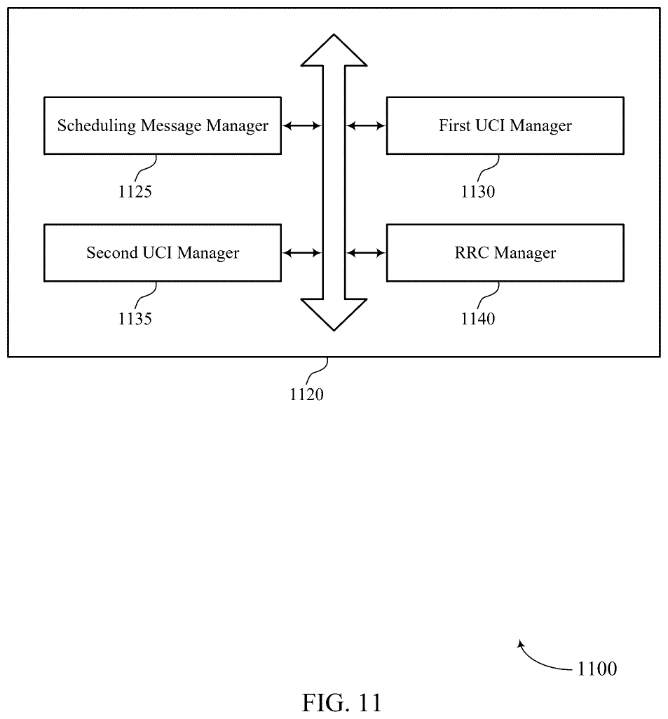

FIG. 11 shows a block diagram 1100 of a communications manager 1120 that supports signaling for transmission of UCI in a CC group in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of signaling for transmission of UCI in a CC group as described herein. For example, the communications manager 1120 may include a scheduling message manager 1125, a first UCI manager 1130, a second UCI manager 1135, an RRC manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The scheduling message manager 1125 is capable of, configured to, or operable to support a means for outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group. The first UCI manager 1130 is capable of, configured to, or operable to support a means for obtaining, via the first cell of the first cell group in accordance with the one or more first control messages, the first UCI carrying the feedback associated with the downlink transmission in the first cell group. The second UCI manager 1135 is capable of, configured to, or operable to support a means for obtaining, via the second cell of the second cell group and a resource of the second cell that is based on the one or more first control messages, the second UCI carrying the feedback associated with the downlink transmission in the first cell group.

In some examples, the first slot offset indicator field indicates a first quantity of slots between the downlink transmission and the first UCI, the second slot offset indicator field indicates a second quantity of slots between the downlink transmission and the second UCI or between the first UCI and the second UCI, and the resource of the second cell includes a slot that is based on the second slot offset indicator field.

In some examples, the RRC manager 1140 is capable of, configured to, or operable to support a means for outputting an RRC message including an indication of a set of multiple slot offsets, where the second quantity of slots is one of the set of multiple slot offsets.

In some examples, the one or more first control messages include a first PRI field associated with the first UCI and a second PRI field associated with the second UCI. In some examples, the resource is based on the second PRI field.

In some examples, the RRC manager 1140 is capable of, configured to, or operable to support a means for outputting one or more RRC messages indicating a first set of multiple PUCCH resources allocated for the first UCI and a second set of multiple PUCCH resources allocated for the second UCI, where the second set of multiple PUCCH resources include the resource.

In some examples, the resource is included in a CG-PUSCH of the second cell group.

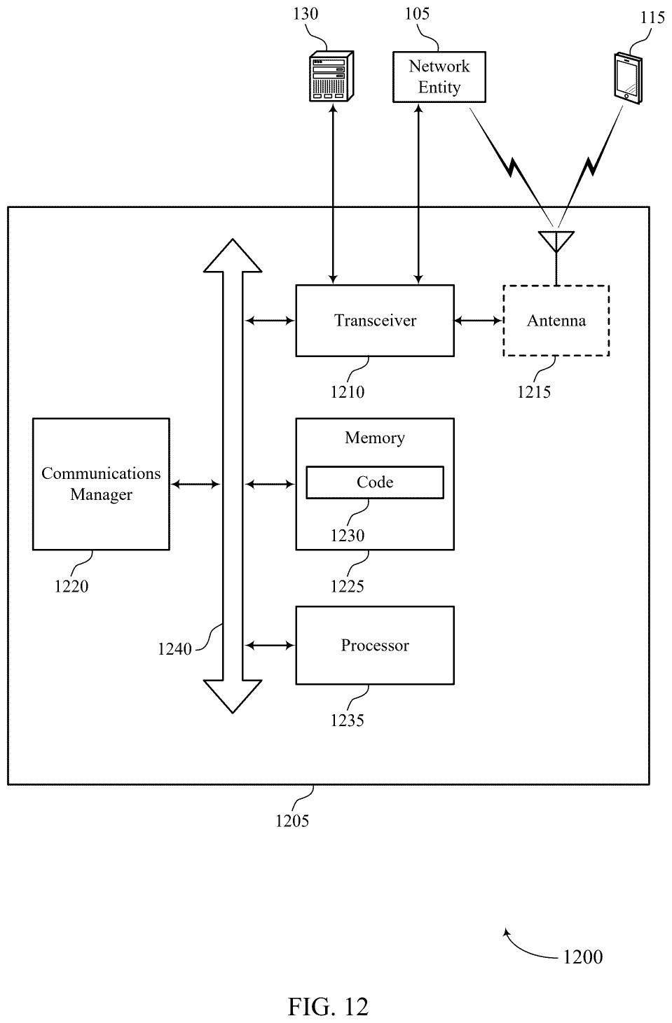

FIG. 12 shows a diagram of a system 1200 including a device 1205 that supports signaling for transmission of UCI in a CC group in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting signaling for transmission of UCI in a CC group). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group. The communications manager 1220 is capable of, configured to, or operable to support a means for obtaining, via the first cell of the first cell group in accordance with the one or more first control messages, the first UCI carrying the feedback associated with the downlink transmission in the first cell group. The communications manager 1220 is capable of, configured to, or operable to support a means for obtaining, via the second cell of the second cell group and a resource of the second cell that is based on the one or more first control messages, the second UCI carrying the feedback associated with the downlink transmission in the first cell group.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of signaling for transmission of UCI in a CC group as described herein, or the at least one processor 1235 and the at least one memory 1225 may be otherwise configured to, individually or collectively, perform or support such operations.

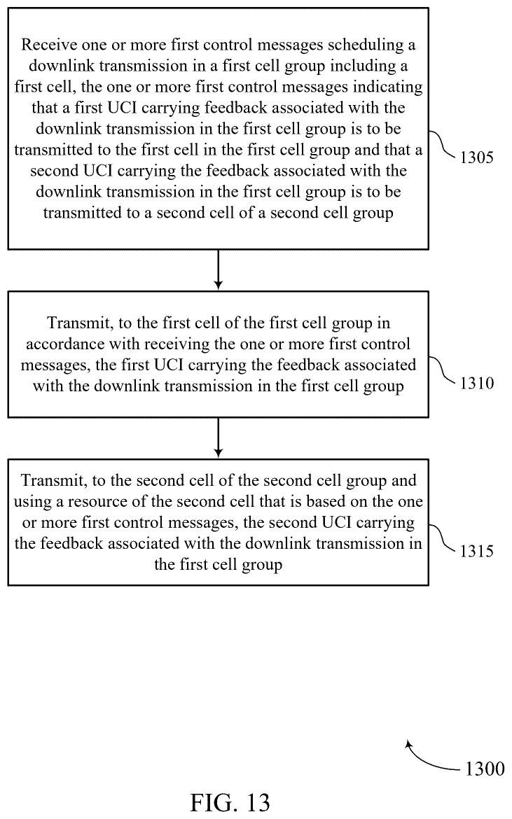

FIG. 13 shows a flowchart illustrating a method 1300 that supports signaling for transmission of UCI in a CC group in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving one or more first control messages scheduling a downlink transmission in a first cell group (e.g., a SCG) including a first cell (e.g., PSCell), the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell (e.g., PCell) of a second cell group (e.g., MCG). The one or more first control messages may be received from a high-band RU/DU of a first network entity. The operations of 1305 may be performed in accordance with examples as disclosed herein. In some examples, aspects of the operations of 1305 may be performed by a scheduling message component 725 as described with reference to FIG. 7.

At 1310, the method may include transmitting, to the first cell of the first cell group (e.g., the high-band RU/DU) in accordance with receiving the one or more first control messages, the first UCI carrying the feedback associated with the downlink transmission in the first cell group. The operations of 1310 may be performed in accordance with examples as disclosed herein. In some examples, aspects of the operations of 1310 may be performed by a first UCI component 730 as described with reference to FIG. 7.

At 1315, the method may include transmitting, to the second cell of the second cell group and using a resource of the second cell that is based on the one or more first control messages, the second UCI carrying the feedback associated with the downlink transmission in the first cell group. The second UCI may be transmitted to a low band RU/DU of the first network entity or a second network entity. The operations of 1315 may be performed in accordance with examples as disclosed herein. In some examples, aspects of the operations of 1315 may be performed by a second UCI component 735 as described with reference to FIG. 7.

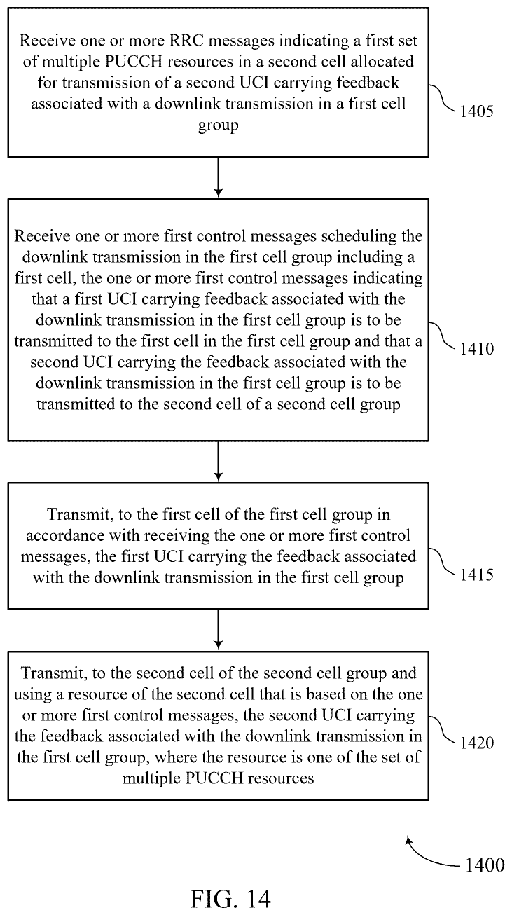

FIG. 14 shows a flowchart illustrating a method 1400 that supports signaling for transmission of UCI in a CC group in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving one or more RRC messages indicating a first set of multiple PUCCH resources in the second cell allocated for transmission of the second UCI carrying the feedback associated with the downlink transmission in the first cell group. The operations of 1405 may be performed in accordance with examples as disclosed herein. In some examples, aspects of the operations of 1405 may be performed by an RRC component 740 as described with reference to FIG. 7.

At 1410, the method may include receiving one or more first control messages scheduling a downlink transmission in a first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group. The operations of 1410 may be performed in accordance with examples as disclosed herein. In some examples, aspects of the operations of 1410 may be performed by a scheduling message component 725 as described with reference to FIG. 7.

At 1415, the method may include transmitting, to the first cell of the first cell group in accordance with receiving the one or more first control messages, the first UCI carrying the feedback associated with the downlink transmission in the first cell group. The operations of 1415 may be performed in accordance with examples as disclosed herein. In some examples, aspects of the operations of 1415 may be performed by a first UCI component 730 as described with reference to FIG. 7.

At 1420, the method may include transmitting, to the second cell of the second cell group and using a resource of the second cell that is based on the one or more first control messages, the second UCI carrying the feedback associated with the downlink transmission in the first cell group. The operations of 1420 may be performed in accordance with examples as disclosed herein. In some examples, aspects of the operations of 1420 may be performed by a second UCI component 735 as described with reference to FIG. 7, where the resource is one of the set of multiple PUCCH resources.

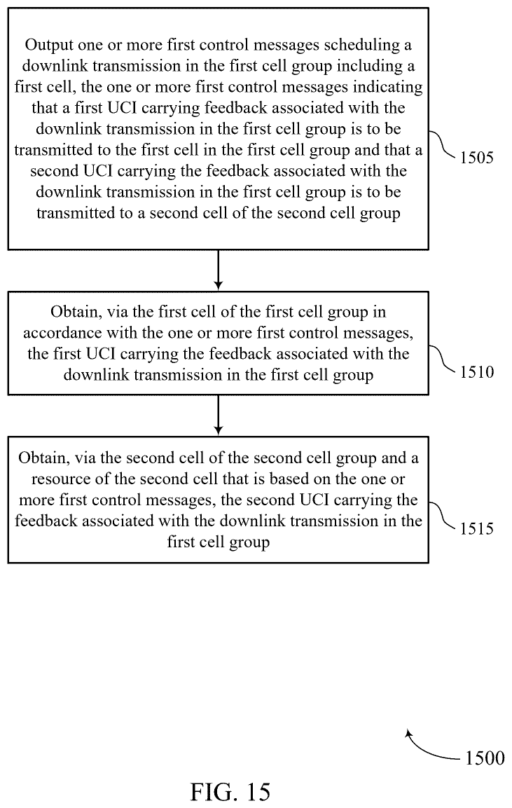

FIG. 15 shows a flowchart illustrating a method 1500 that supports signaling for transmission of UCI in a CC group in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group. The operations of 1505 may be performed in accordance with examples as disclosed herein. In some examples, aspects of the operations of 1505 may be performed by a scheduling message manager 1125 as described with reference to FIG. 11.

At 1510, the method may include obtaining, via the first cell of the first cell group in accordance with the one or more first control messages, the first UCI carrying the feedback associated with the downlink transmission in the first cell group. The operations of 1510 may be performed in accordance with examples as disclosed herein. In some examples, aspects of the operations of 1510 may be performed by a first UCI manager 1130 as described with reference to FIG. 11.

At 1515, the method may include obtaining, via the second cell of the second cell group and a resource of the second cell that is based on the one or more first control messages, the second UCI carrying the feedback associated with the downlink transmission in the first cell group. The operations of 1515 may be performed in accordance with examples as disclosed herein. In some examples, aspects of the operations of 1515 may be performed by a second UCI manager 1135 as described with reference to FIG. 11.

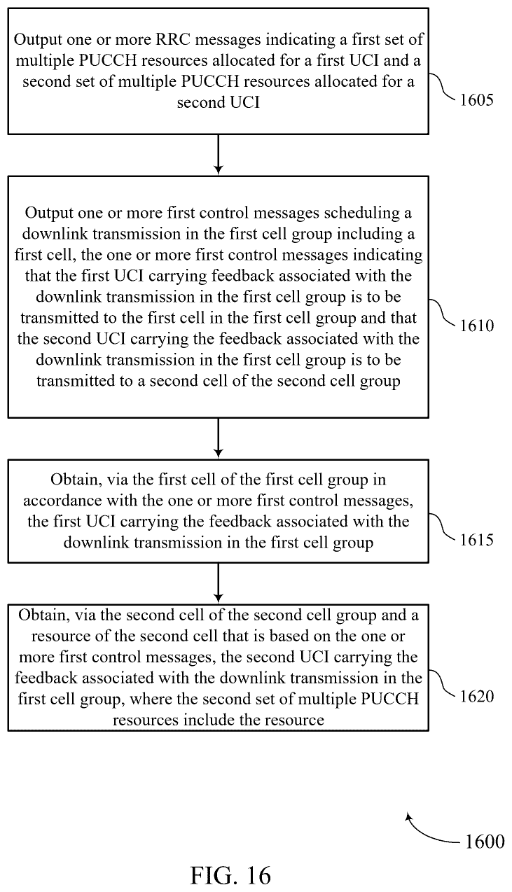

FIG. 16 shows a flowchart illustrating a method 1600 that supports signaling for transmission of UCI in a CC group in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting one or more RRC messages indicating a first set of multiple PUCCH resources allocated for the first UCI and a second set of multiple PUCCH resources allocated for the second UCI. The operations of 1605 may be performed in accordance with examples as disclosed herein. In some examples, aspects of the operations of 1605 may be performed by an RRC manager 1140 as described with reference to FIG. 11.

At 1610, the method may include outputting one or more first control messages scheduling a downlink transmission in the first cell group including a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group. The operations of 1610 may be performed in accordance with examples as disclosed herein. In some examples, aspects of the operations of 1610 may be performed by a scheduling message manager 1125 as described with reference to FIG. 11.

At 1615, the method may include obtaining, via the first cell of the first cell group in accordance with the one or more first control messages, the first UCI carrying the feedback associated with the downlink transmission in the first cell group. The operations of 1615 may be performed in accordance with examples as disclosed herein. In some examples, aspects of the operations of 1615 may be performed by a first UCI manager 1130 as described with reference to FIG. 11.

At 1620, the method may include obtaining, via the second cell of the second cell group and a resource of the second cell that is based on the one or more first control messages, the second UCI carrying the feedback associated with the downlink transmission in the first cell group, where the second set of multiple PUCCH resources include the resource. The operations of 1620 may be performed in accordance with examples as disclosed herein. In some examples, aspects of the operations of 1620 may be performed by a second UCI manager 1135 as described with reference to FIG. 12.

The following provides an overview of aspects of the present disclosure:

Aspect 1: A method for wireless communications by a UE, comprising: receiving one or more first control messages scheduling a downlink transmission in a first cell group comprising a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of a second cell group; transmitting, to the first cell of the first cell group in accordance with receiving the one or more first control messages, the first UCI carrying the feedback associated with the downlink transmission in the first cell group; and transmitting, to the second cell of the second cell group and using a resource of the second cell that is based at least in part on the one or more first control messages, the second UCI carrying the feedback associated with the downlink transmission in the first cell group.

Aspect 2: The method of aspect 1, wherein the one or more first control messages comprise a first slot offset indicator field and a second slot offset indicator field, and wherein the first slot offset indicator field indicates a first quantity of slots between the downlink transmission and the first UCI, the second slot offset indicator field indicates a second quantity of slots between the downlink transmission and the second UCI or between the first UCI and the second UCI, and the resource of the second cell comprises a slot that is based at least in part on the second slot offset indicator field.

Aspect 3: The method of aspect 2, further comprising: receiving an RRC message comprising an indication of a plurality of slot offsets, wherein the second quantity of slots is one of the plurality of slot offsets.

Aspect 4: The method of aspect 3, further comprising: constructing a payload of the second UCI based at least in part on a semi-static codebook in accordance with a set of candidate PDSCH receptions that are based at least in part on the plurality of slot offsets.

Aspect 5: The method of any of aspects 1 through 4, wherein the resource comprises a first available uplink slot of a reference component carrier of the second cell group.

Aspect 6: The method of aspect 5, wherein the first available uplink slot occurs after a first slot in which downlink transmission is received by the UE, after a quantity of slots after the first slot, or after a second slot in which the first UCI is transmitted by the UE.

Aspect 7: The method of any of aspects 5 through 6, further comprising: receiving an indication of a semi-static TDD configuration of the reference component carrier, wherein the first available uplink slot includes one or more uplink symbols, one or more flexible symbols, or both based at least in part on the semi-static TDD configuration.

Aspect 8: The method of any of aspects 5 through 7, further comprising: receiving one or more RRC messages comprising an indication of a periodic pattern, wherein the periodic pattern comprises the first available uplink slot.

Aspect 9: The method of any of aspects 5 through 8, wherein the reference component carrier comprises a PUCCH cell of the second cell group, a component carrier having a lowest index within the second cell group, or a component carrier with a lowest subcarrier spacing within the second cell group.

Aspect 10: The method of any of aspects 1 through 9, wherein the resource comprises a slot that is based at least in part on a slot offset indicator or a first available uplink slot of a reference component carrier in accordance with an RRC configuration or a format of the one or more first control messages.

Aspect 11: The method of any of aspects 1 through 10, wherein the one or more first control messages comprise a first PRI field associated with the first UCI and a second PRI field associated with the second UCI, and the resource is based at least in part on the second PRI field.

Aspect 12: The method of any of aspects 1 through 11, wherein the resource is based at least in part on a payload size of the second UCI.

Aspect 13: The method of any of aspects 1 through 12, further comprising: receiving one or more RRC messages indicating a first plurality of PUCCH resources in the second cell allocated for transmission of the second UCI carrying the feedback associated with the downlink transmission in the first cell group, wherein the resource is one of the plurality of PUCCH resources.

Aspect 14: The method of any of aspects 1 through 13, wherein the resource is included in a configured grant PUSCH of the second cell group.

Aspect 15: The method of aspect 14, wherein the one or more first control messages further comprise a configured grant configuration identifier that references the second cell group, and the resource is included in configured grant PUSCH based at least in part on the configured grant configuration identifier.

Aspect 16: The method of any of aspects 14 through 15, wherein the configured grant PUSCH carrying the second UCI is from a plurality of configured grant PUSCH occasions, the configured grant PUSCH occurs on or after a slot that is based at least in part on the one or more first control messages.

Aspect 17: The method of any of aspects 1 through 16, wherein the feedback of the second UCI is based at least in part on a one-shot codebook in accordance with the one or more first control messages comprising a field indicative of the one-shot codebook.

Aspect 18: The method of aspect 17, wherein the one or more first control messages indicate one or more HARQ process identifiers, component carriers, or both for which the one-shot codebook is configured for the feedback of the second UCI.

Aspect 19: The method of any of aspects 1 through 18, wherein the feedback of the second UCI is based at least in part on a dynamic codebook in accordance with the one or more first control messages comprising one or more DAI fields.

Aspect 20: The method of aspect 19, wherein the one or more DAI fields comprise a first DAI field associated with the first UCI, a second DAI field associated with the second UCI, or a third DAI field associated with the first UCI and the second UCI.

Aspect 21: The method of any of aspects 1 through 20, further comprising: receiving a first RRC message indicating a first codebook type for the feedback of the first UCI; and receiving a second RRC message separate from the first RRC message indicating a second codebook type for the feedback of the second UCI.

Aspect 22: The method of any of aspects 1 through 21, wherein transmitting the second UCI comprises: transmitting the second UCI using a transmit power that is based at least in part on a first transmit power control command of first downlink control information that schedules the downlink transmission in the first cell group.

Aspect 23: The method of aspect 22, wherein transmitting the first UCI comprises: transmitting the first UCI using a transmit power that is based at least in part on the first transmit power control command of the first downlink control information that schedules the downlink transmission in the first cell group.

Aspect 24: The method of any of aspects 1 through 23, wherein transmitting the second UCI comprises: transmitting the second UCI using a transmit power that is based at least in part on a first transmit power control command of first downlink control information received in the second cell group.

Aspect 25: The method of any of aspects 1 through 24, further comprising: transmitting the second UCI to the second cell of the second cell group via the resource that is time-division multiplexed with a second resource of the second cell or via the resource that is on a first channel of the second cell that comprises a second channel carrying information for the second cell group.

Aspect 26: The method of any of aspects 1 through 25, further comprising: refraining from transmitting information for the second cell group based at least in part on the resource overlapping with at least a portion of a second resource scheduling for carrying the information for the second cell group.

Aspect 27: The method of any of aspects 1 through 26, further comprising: multiplexing the second UCI with information for the second cell group based at least in part on the resource that is to carry the feedback at least partially overlapping with a second resource that is to carry the information for the second cell group.

Aspect 28: The method of any of aspects 1 through 27, further comprising: determining whether to multiplex the second UCI with information for the second cell group based at least in part on the resource that is to carry the second UCI at least partially overlapping with a second resource that is to carry the information for the second cell group, wherein the UE determines to multiplex the second UCI with the information when the information is not second feedback associated with a downlink transmission in the second cell group, and wherein the UE determines to transmit the second UCI separate from the information when the information comprises the second feedback associated with the downlink transmission in the second cell group.

Aspect 29: A method for wireless communications by a network entity supporting a first cell group and a second cell group, comprising: outputting one or more first control messages scheduling a downlink transmission in the first cell group comprising a first cell, the one or more first control messages indicating that a first UCI carrying feedback associated with the downlink transmission in the first cell group is to be transmitted to the first cell in the first cell group and that a second UCI carrying the feedback associated with the downlink transmission in the first cell group is to be transmitted to a second cell of the second cell group; obtaining, via the first cell of the first cell group in accordance with the one or more first control messages, the first UCI carrying the feedback associated with the downlink transmission in the first cell group; and obtaining, via the second cell of the second cell group and a resource of the second cell that is based at least in part on the one or more first control messages, the second UCI carrying the feedback associated with the downlink transmission in the first cell group.

Aspect 30: The method of aspect 29, wherein the one or more first control messages comprise a first slot offset indicator field and a second slot offset indicator field, and wherein the first slot offset indicator field indicates a first quantity of slots between the downlink transmission and the first UCI, the second slot offset indicator field indicates a second quantity of slots between the downlink transmission and the second UCI or between the first UCI and the second UCI, and the resource of the second cell comprises a slot that is based at least in part on the second slot offset indicator field.

Aspect 31: The method of aspect 30, further comprising: transmitting an RRC message comprising an indication of a plurality of slot offsets, wherein the second quantity of slots is one of the plurality of slot offsets.

Aspect 32: The method of any of aspects 29 through 31, wherein the one or more first control messages comprise a first PRI field associated with the first UCI and a second PRI field associated with the second UCI, and the resource is based at least in part on the second PRI field.

Aspect 33: The method of any of aspects 29 through 32, further comprising: outputting one or more RRC messages indicating a first plurality of PUCCH resources allocated for the first UCI and a second plurality of PUCCH resources allocated for the second UCI, wherein the second plurality of PUCCH resources comprise the resource.

Aspect 34: The method of any of aspects 29 through 33, wherein the resource is included in a configured grant PUSCH of the second cell group.

Aspect 35: A UE for wireless communications, comprising one or more memories storing processor-executable code, and one or more processors coupled with the one or more memories and individually or collectively operable to execute the code to cause the UE to perform a method of any of aspects 1 through 28.

Aspect 36: A UE for wireless communications, comprising at least one means for performing a method of any of aspects 1 through 28.

Aspect 37: A non-transitory computer-readable medium storing code for wireless communications, the code comprising instructions executable by one or more processors to perform a method of any of aspects 1 through 28.

Aspect 38: A network entity supporting a first cell group and a second cell group for wireless communications, comprising one or more memories storing processor-executable code, and one or more processors coupled with the one or more memories and individually or collectively operable to execute the code to cause the network entity supporting a first cell group and a second cell group to perform a method of any of aspects 29 through 34.

Aspect 39: A network entity supporting a first cell group and a second cell group for wireless communications, comprising at least one means for performing a method of any of aspects 29 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ” As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components. ” The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more first control messages scheduling a downlink transmission in a first cell group comprising a first cell, the one or more first control messages indicating that a first uplink control information (UCI) carrying feedback associated with the downlink transmission in the first cell group is to be transmitted to the first cell in the first cell group and that a second UCI carrying the feedback associated with the downlink transmission in the first cell group is to be transmitted to a second cell of a second cell group;
transmit, to the first cell of the first cell group in accordance with receiving the one or more first control messages, the first UCI carrying the feedback associated with the downlink transmission in the first cell group; and
transmit, to the second cell of the second cell group and using a resource of the second cell that is based at least in part on the one or more first control messages, the second UCI carrying the feedback associated with the downlink transmission in the first cell group.

2. The UE of claim 1, wherein the one or more first control messages comprise a first slot offset indicator field and a second slot offset indicator field, and wherein:
the first slot offset indicator field indicates a first quantity of slots between the downlink transmission and the first UCI,
the second slot offset indicator field indicates a second quantity of slots between the downlink transmission and the second UCI or between the first UCI and the second UCI, and
the resource of the second cell comprises a slot that is based at least in part on the second slot offset indicator field.

3. The UE of claim 2, wherein the one or more processors are individually or collectively further operable to execute the code to cause the UE to:
receive a radio resource control (RRC) message comprising an indication of a plurality of slot offsets, wherein the second quantity of slots is one of the plurality of slot offsets.

4. The UE of claim 3, wherein the one or more processors are individually or collectively further operable to execute the code to cause the UE to:
construct a payload of the second UCI based at least in part on a semi-static codebook in accordance with a set of candidate physical downlink shared channel (PDSCH) receptions that are based at least in part on the plurality of slot offsets.

5. The UE of claim 1, wherein the resource comprises a first available uplink slot of a reference component carrier of the second cell group.

6. The UE of claim 5, wherein the first available uplink slot occurs after a first slot in which the downlink transmission is received by the UE, after a quantity of slots after the first slot, or after a second slot in which the first UCI is transmitted by the UE.

7. The UE of claim 5, wherein the one or more processors are individually or collectively further operable to execute the code to cause the UE to:
receive an indication of a semi-static time division duplexing (TDD) configuration of the reference component carrier, wherein the first available uplink slot includes one or more uplink symbols, one or more flexible symbols, or both based at least in part on the semi-static TDD configuration.

8. The UE of claim 5, wherein the one or more processors are individually or collectively further operable to execute the code to cause the UE to:
receive one or more radio resource control (RRC) messages comprising an indication of a periodic pattern, wherein the periodic pattern comprises the first available uplink slot.

9. The UE of claim 5, wherein the reference component carrier comprises a physical uplink control channel (PUCCH) cell of the second cell group, a component carrier having a lowest index within the second cell group, or a component carrier with a lowest subcarrier spacing within the second cell group.

10. The UE of claim 1, wherein the resource comprises a slot that is based at least in part on a slot offset indicator or a first available uplink slot of a reference component carrier in accordance with a radio resource control (RRC) configuration or a format of the one or more first control messages.

11. The UE of claim 1, wherein:
the one or more first control messages comprise a first physical uplink control channel (PUCCH) resource indicator (PRI) field associated with the first UCI and a second PRI field associated with the second UCI, and
the resource is based at least in part on the second PRI field.

12. The UE of claim 1, wherein the resource is based at least in part on a payload size of the second UCI.

13. The UE of claim 1, wherein the one or more processors are individually or collectively further operable to execute the code to cause the UE to:
receive one or more radio resource control (RRC) messages indicating a first plurality of physical uplink control channel (PUCCH) resources in the second cell allocated for transmission of the second UCI carrying the feedback associated with the downlink transmission in the first cell group, wherein the resource is one of the first plurality of PUCCH resources.

14. The UE of claim 1, wherein the resource is included in a configured grant physical uplink shared channel (PUSCH) of the second cell group.

15. The UE of claim 14, wherein:
the one or more first control messages further comprise a configured grant configuration identifier that references the second cell group, and
the resource is included in a configured grant PUSCH based at least in part on the configured grant configuration identifier.

16. The UE of claim 14, wherein:
the configured grant PUSCH carrying the second UCI is from a plurality of configured grant PUSCH occasions, and
the configured grant PUSCH occurs on or after a slot that is based at least in part on the one or more first control messages.

17. The UE of claim 1, wherein the feedback of the second UCI is based at least in part on a one-shot codebook in accordance with the one or more first control messages comprising a field indicative of the one-shot codebook.

18. The UE of claim 17, wherein the one or more first control messages indicate one or more hybrid automatic repeat request (HARQ) process identifiers, component carriers, or both for which the one-shot codebook is configured for the feedback of the second UCI.

19. The UE of claim 1, wherein the feedback of the second UCI is based at least in part on a dynamic codebook in accordance with the one or more first control messages comprising one or more downlink assignment index (DAI) fields.

20. The UE of claim 19, wherein the one or more DAI fields comprise a first DAI field associated with the first UCI, a second DAI field associated with the second UCI, or a third DAI field associated with the first UCI and the second UCI.

21. The UE of claim 1, wherein the one or more processors are individually or collectively further operable to execute the code to cause the UE to:
receive a first radio resource control (RRC) message indicating a first codebook type for the feedback of the first UCI; and
receive a second RRC message separate from the first RRC message indicating a second codebook type for the feedback of the second UCI.

22. The UE of claim 1, wherein, to transmit the second UCI, the one or more processors are individually or collectively operable to execute the code to cause the UE to:
transmit the second UCI using a transmit power that is based at least in part on a first transmit power control command of first downlink control information that schedules the downlink transmission in the first cell group.

23. The UE of claim 22, wherein, to, the one or more processors are individually or collectively operable to execute the code to cause the UE to:
transmit the first UCI using a transmit power that is based at least in part on the first transmit power control command of the first downlink control information that schedules the downlink transmission in the first cell group.

24. The UE of claim 1, wherein, to transmit the second UCI, the one or more processors are individually or collectively operable to execute the code to cause the UE to:
transmit the second UCI using a transmit power that is based at least in part on a first transmit power control command of first downlink control information received in the second cell group.

25. The UE of claim 1, wherein the one or more processors are individually or collectively further operable to execute the code to cause the UE to:
transmit the second UCI to the second cell of the second cell group via the resource that is time-division multiplexed with a second resource of the second cell or via the resource that is on a first channel of the second cell that comprises a second channel carrying information for the second cell group.

26. The UE of claim 1, wherein the one or more processors are individually or collectively further operable to execute the code to cause the UE to:
refrain from transmitting information for the second cell group based at least in part on the resource overlapping with at least a portion of a second resource scheduling for carrying the information for the second cell group.

27. The UE of claim 1, wherein the one or more processors are individually or collectively further operable to execute the code to cause the UE to:
multiplex the second UCI with information for the second cell group based at least in part on the resource that is to carry the feedback at least partially overlapping with a second resource that is to carry the information for the second cell group.

28. A network entity supporting a first cell group and a second cell group, comprising:
one or more memories storing processor-executable code; and
one or more processors coupled with the one or more memories and individually or collectively operable to execute the code to cause the network entity to:
output one or more first control messages scheduling a downlink transmission in the first cell group comprising a first cell, the one or more first control messages indicating that a first uplink control information (UCI) carrying feedback associated with the downlink transmission in the first cell group is to be transmitted to the first cell in the first cell group and that a second UCI carrying the feedback associated with the downlink transmission in the first cell group is to be transmitted to a second cell of the second cell group;
obtain, via the first cell of the first cell group in accordance with the one or more first control messages, the first UCI carrying the feedback associated with the downlink transmission in the first cell group; and
obtain, via the second cell of the second cell group and a resource of the second cell that is based at least in part on the one or more first control messages, the second UCI carrying the feedback associated with the downlink transmission in the first cell group.

29. A method for wireless communications by a user equipment (UE), comprising:
receiving one or more first control messages scheduling a downlink transmission in a first cell group comprising a first cell, the one or more first control messages indicating that a first uplink control information (UCI) carrying feedback associated with the downlink transmission in the first cell group is to be transmitted to the first cell in the first cell group and that a second UCI carrying the feedback associated with the downlink transmission in the first cell group is to be transmitted to a second cell of a second cell group;
transmitting, to the first cell of the first cell group in accordance with receiving the one or more first control messages, the first UCI carrying the feedback associated with the downlink transmission in the first cell group; and
transmitting, to the second cell of the second cell group and using a resource of the second cell that is based at least in part on the one or more first control messages, the second UCI carrying the feedback associated with the downlink transmission in the first cell group.

30. A method for wireless communications by a network entity supporting a first cell group and a second cell group, comprising:
outputting one or more first control messages scheduling a downlink transmission in the first cell group comprising a first cell, the one or more first control messages indicating that a first uplink control information (UCI) carrying feedback associated with the downlink transmission in the first cell group is to be transmitted to the first cell in the first cell group and that a second UCI carrying the feedback associated with the downlink transmission in the first cell group is to be transmitted to a second cell of the second cell group;
obtaining, via the first cell of the first cell group in accordance with the one or more first control messages, the first UCI carrying the feedback associated with the downlink transmission in the first cell group; and
obtaining, via the second cell of the second cell group and a resource of the second cell that is based at least in part on the one or more first control messages, the second UCI carrying the feedback associated with the downlink transmission in the first cell group.
